(19) United States
(12) Patent Application Publication
(10) Pub. No.: US 2006/0164020 A1
(43) Pub. Date: Jul. 27, 2006

(54) Plasma display panel and plasma display device

(76) Inventors: Takayuki Kobayashi, Machida (JP); Takashi Sasaki, Hiratsuka (JP); Naoki Itokawa, Kawasaki (JP); Toru Teraoka, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/336,961

(22) Filed: Jan. 23, 2006

(30) Foreign Application Priority Data
Jan. 24, 2005 (JP) 2005-015156

(51) Int. Cl. G09G 3/10

(52) U.S. Cl. 315/169.3

(57) ABSTRACT

A plasma display panel capable of reducing a peak value of a sustain discharge current without generating luminance nonuniformity is provided. The plasma display panel comprises: a plurality of first, second, and third electrodes disposed to be adjacent to each other and extending in a first direction, the third electrodes being provided between the first electrodes and the second electrodes where the discharge is repeated; and a dielectric layer covering the electrodes, wherein the space between the first electrode and the second electrode is approximately constant over an entire display area width of the panel, and a space between the third electrode and the first and second electrodes is varied depending on positions in the entire display area width of the panel in a first direction.

### CROSS-REFERENCE TO RELATED APPLICATION

The present application claims priority from Japanese Patent Application No. JP 2005-15156 filed on Jan. 24, 2005, the content of which is hereby incorporated by reference into this application.

### TECHNICAL FIELD OF THE INVENTION

The present invention relates to an A/C plasma display panel (PDP) and a plasma display device (PDP device) used for a display device of a personal computer and a workstation, a flat TV, and a plasma display for displaying advertisements, information, and others.

### BACKGROUND OF THE INVENTION

In AC color PDP devices, an address/display separation (ADS) method in which a period when the cells to be displayed are determined (address period) and a display period when discharges for display lighting are performed (sustain period) are separated is widely employed. In this method, charge is accumulated in the cells, which are to be turned on, in the address period, and discharges for display are performed by utilizing the charge in the sustain period.

Also, plasma display panels include: a two-electrode type PDP in which a plurality of first electrodes extending in a first direction are provided in parallel to each other and a plurality of second electrodes extending in a second direction which is perpendicular to the first direction are provided in parallel to each other; and a three-electrode type PDP in which a plurality of first electrodes and second electrodes extending in a first direction are alternately provided in parallel to each other and a plurality of third electrodes extending in a second direction perpendicular to the first direction are provided in parallel to each other. In recent years, the three-electrode type PDPs have been widely used.

In a general structure of the three-electrode type PDPs, first (X) electrodes and second (Y) electrodes are alternately provided in parallel to each other on a first substrate, address electrodes extending in a direction which is perpendicular to the extending direction of the first and second electrodes are provided on a second substrate opposite to the first substrate, and the surfaces of the electrodes are covered by dielectric layers. On the second substrate, barrier ribs which are extending in one direction and arranged in stripes between the address electrodes in parallel to the address electrodes or barrier ribs which are arranged in lattice pattern and disposed in parallel to the address electrodes and the first and second electrodes so as to individually separate the cells are further provided, and the first and the second substrates are attached to each other after phosphor layers are formed between the barrier ribs. Therefore, the dielectric layers and the phosphor layers and further the barrier ribs are formed on the address electrodes.

After applying voltage between the first and second electrodes to make the charges (wall charge) near the electrodes of all cells uniform, the addressing for selectively leaving the wall charge in the cells to be turned on is performed by sequentially applying scan pulses to the second electrodes and applying address pulses to the address electrodes in synchronization with the scan pulses. Subsequently, sustain discharge pulses which alternately change the polarities of the adjacent two electrodes where discharges are to be performed are applied to the first and second electrodes. By doing so, the sustain discharges are performed in the cells to be turned on in which the wall charge has been left through the addressing, thereby performing the lighting. The phosphor layers emit light by ultraviolet rays generated through the discharges, and the light is seen through the first substrate. Therefore, the first and second electrodes are comprised of non-transparent bus electrodes formed of metal materials and transparent electrodes such as ITO films, and the light generated in the phosphor layers can be seen through the transparent electrodes. Since structures and operations of general PDPs are widely known, detailed descriptions thereof will be omitted here.

In the field of the above-described three-electrode type PDP, various types of PDPs in which third electrodes are respectively provided between the first electrodes and the second electrodes in parallel thereto have been proposed.

For example, Japanese Patent Application Laid-Open Publication No. 2001-34228 (Patent Document 1) discloses the structure in which third electrodes are provided between first electrodes and second electrodes where discharge is not performed (non-display line) so that the third electrodes are utilized for trigger operations, prevention of discharges in non-display lines (prevention of reverse slit), reset operations, and others.

Also, the PDP has a large number of first, second, and address electrodes and a high voltage is applied to these electrodes when performing the discharge. A large discharge current flowing at the time of discharge poses a problem of luminance reduction due to a voltage drop in elongated electrodes, and this reduction in luminance depends on a load factor. This is a phenomenon in which the current instantaneously flowing through the elongated electrodes is increased due to the concentration of discharge timings, and the voltage drop at ends of the elongated electrodes is increased. The occurrence of a difference in driving voltage between both ends of the panel will pose a problem of the reduction of an operating voltage margin.

Japanese Patent Application Laid-Open Publication No. 2004-205655 (Patent Document 2) discloses a technology in which spaces between first and second electrodes are gradually changed depending on positions on a panel in order to increase the driving voltage margin.

Furthermore, a driving circuit with a large driving current is required in order to drive electrodes. Since the driving capability of the driving circuit is defined by a peak value of a discharge current, the peak value of the discharge current is desired to be reduced. Therefore, Japanese Patent Application Laid-Open Publication No. 7-29498 (Patent Document 3) discloses a technology in which spaces between electrodes where the discharge is performed are gradually changed depending on positions on a panel so as to distribute the discharge current and reduce the peak value.

Although such technologies of widening the operating voltage margin by gradually changing the spaces between the electrodes and reducing the peak value of the discharge current have been suggested as described above, the space between the first electrode and the second electrode for sustain discharge in standard PDPs is constant, and so is the space between the first and second electrodes and the third electrode provided therebetween.

### SUMMARY OF THE INVENTION

Patent Documents 2 and 3 disclose the technologies in which the operating voltage margin is widened and the peak value of the discharge current is reduced by gradually varying the spaces between the first electrodes and the second electrodes. However, in the structures disclosed in Patent Documents 2 and 3, the area of the first electrode and the second electrode is varied and the space between the first electrode and the second electrode is varied depending on the positions of the panel. Therefore, the intensity of the sustain discharge for each cell is varied depending on the positions of the panel, and the problem of the luminance nonuniformity occurs.

An object of the present invention is to realize a plasma display panel in which the operating voltage margin is widened and the peak value of the discharge current is reduced without generating luminance nonuniformity.

In order to achieve the above-described object, according to a plasma display panel (PDP) of the present invention, in a PDP provided with the first (X) electrode, the second (Y) electrodes and address electrodes, third (Z) electrodes are provided between the first electrodes and the second electrodes between which discharges are to be repeated, and spaces between the first electrodes and the second electrodes are approximately constant throughout the entire display area width of the plasma display panel and spaces between the third electrodes and the first and second electrodes are varied depending on their positions in the entire display area width of the plasma display panel.

More specifically, the plasma display panel (PDP) according to the present invention comprises: a plurality of first, second, and third electrodes disposed to be adjacent to each other and extending in a first direction, the third electrodes being provided respectively between the first and second electrodes where discharges are to be repeated; and a dielectric layer covering the plurality of first, second, and third electrodes, wherein a space between the first electrode and the second electrode for performing the discharges is approximately constant over an entire display area width of the plasma display panel, and a space between the third electrode and the first and second electrodes is varied depending on positions in the first direction of the entire display area width of the plasma display panel.

As in the PDP, in the case where discharge gas is enclosed in a discharge space and discharge is generated between two electrodes, it is known that a discharge threshold voltage (firing voltage) is determined based on the product of the distance between the two electrodes and the pressure of the discharge gas, and the curve representing the changing relation between the product on the horizontal axis and the firing voltage on the horizontal axis is called a Paschen curve. The Paschen curve takes the minimum value when the product of the distance between the two electrodes and the pressure of the discharge gas takes a certain value, and this state is called the Paschen minimum. According to the distance between the first electrode and the second electrode and the pressure of the discharge gas in the conventional PDP, the product is considerably larger than the Paschen minimum, and this value can achieve a higher luminous efficiency than a value closer to the Paschen minimum.

In the PDP of the present invention, the third (Z) electrode is provided between the first (X) electrode and the second (Y) electrode, and the space between the third electrode and the first and second electrodes is narrower than the space between the first electrode and the second electrode. Therefore, the firing voltage of a discharge between the third electrode and the first and second electrodes is lower than that of a discharge between the first and second electrodes, and a discharge tends to occur more readily between the third electrode and the first and second electrodes. Once a discharge occurs, the discharge easily expands to the space between the first electrode and the second electrode, and the discharge with high luminous efficiency is performed. In the PDP according to the present invention, the space between the third electrode and the first and second electrodes is varied depending on their positions in the entire display area width of the plasma display panel. Therefore, the firing voltage differs depending on the cell position, a discharge occurs earlier in a cell with a narrow space, and a discharge occurs later in a cell with a wide space. More specifically, discharge start timing differs in each cell. Accordingly, the timing of a main discharge between the first electrode and the second electrode also differs, and a current of a sustain discharge is distributed in the entire panel. Also, since the areas of the first electrode and the second electrode and the space therebetween are identical in each cell, a main discharge of a sustain discharge in each cell has the same intensity, and the luminance nonuniformity can be prevented.

The first electrode is formed of a first transparent electrode which allows visible light to pass and a first metal electrode having a low electrical resistance value, and the second electrode is formed of a second transparent electrode which allows visible light to pass and a second metal electrode having a low electrical resistance value. The first metal electrode and the second metal electrode are disposed in parallel to each other over the entire display area width of the plasma display panel.

The first and second transparent electrodes may have a straight shape, or may have portions protruding from the first and second metal electrodes for each cell and the discharge may be performed at these protruding portions. In this case, opposing edges of the protruding portions of the first and second transparent electrodes are formed approximately in parallel to the first and second metal electrodes.

Similarly, the third electrode is formed of a third transparent electrode which allows visible light to pass and a third metal electrode having a low electrical resistance value. The structure in which a space between the third transparent electrode and the first and second electrodes is varied depending on positions in the entire display area width of the plasma display panel can be achieved in various shapes in the first direction.

For example, the third metal electrode and the third transparent electrode are disposed so as to linearly extend over the entire display area width of the plasma display panel to form a predetermined angle with the first metal electrode and the second metal electrode. In this case, it is desired that the third metal electrode and the third transparent electrode overlap each other so as to have a width as narrow as possible. Note that, instead of the linearly extending shape of the third metal electrode and the third transparent electrode, the third metal electrode and the third transparent electrode may have a stepwise shape in which the edges are parallel to the edges of the first and second metal electrodes and the spaces with the edges of the first and second metal electrodes are gradually varied over the entire display area width of the plasma display panel or a shape in which the edges extend in a zigzag manner over the entire display area width of the plasma display panel.

Furthermore, the structure is also preferable, in which only the third metal electrodes linearly extend over the entire display area width of the plasma display panel approximately in parallel to the first and second metal electrodes, and a space between the edge of the third transparent electrode and the edges of the first and second transparent electrodes is varied depending on the positions in the entire display area width of the plasma display panel in the first direction. In this case, a portion of the third transparent electrode which does not overlap the third metal electrode is increased.

For example, the edge of the third transparent electrode is disposed so as to linearly extend over the entire display area width of the plasma display panel to form a predetermined angle with the first and second metal electrodes. In this case, if the third transparent electrode has a shape of a parallelogram, the width of the third transparent electrode is approximately constant over the entire display area width of the plasma display panel. If the third transparent electrode has a shape of a trapezoid, the width of the third transparent electrode is varied.

Furthermore, the width of the third transparent electrode may be adjusted so that it is increased at the center of the display area width of the plasma display panel and is decreased at portions near ends of the display area width in the first direction. In this case, a space between the edge of the third transparent electrode and the edges of the first and second transparent electrodes is narrow at the center of the display area width of the plasma display panel and is wide at portions near the ends of the display area width. Conversely, the width of the third transparent electrode may be adjusted so that it is decreased at center of the display area width of the plasma display panel and is increased at portions near the ends of the display area width in the first direction. In this case, the space between the edge of the third transparent electrode and the edges of the first and second transparent electrodes is wide at the center of the display area width of the plasma display panel and is narrow at portions near the ends of the display area width in the first direction.

Furthermore, it is also possible to form the third electrode from only a third transparent electrode which allows visible light to pass without including a third metal electrode, and it can be achieved in various shapes in a manner similar to those described above.

The dielectric layer covering the first, second, third electrodes is made of silicide compound formed through vapor-phase deposition, and preferably has a thickness of 10 μm or smaller.

In a plasma display device including a plasma display panel according to the present invention, a main discharge for display is preferably performed between the first discharge electrode and the second discharge electrode having a high luminance efficiency. Also, it is desired that a voltage to be applied to the third electrode is controlled so as to use the discharge between the third electrode and the first or second electrode as a trigger. More specifically, when a sustain discharge is performed between the first electrode and the second electrode, simultaneously with or earlier than the time when a sustain discharge voltage is applied between the first electrode and the second electrode, a predetermined voltage is applied between the third electrode and one of the first electrode and the second electrode. By doing so, a discharge is generated between one of the first and second electrodes and the third electrode. With using this discharge as a trigger, a sustain discharge is generated between the first or second electrode and the third electrode. Immediately after the sustain discharge is generated between the first and second electrodes, a voltage to be applied to the third electrode is switched so that a predetermined voltage is applied between the third electrode and the other of the first electrode and the second electrode, thereby stopping the discharge between one of the first electrode and the second electrode and the third electrode.

As described above, if the third electrode is operated so as to generate a trigger discharge and not to be related to the main discharge, the difference in luminance among the cells can be suppressed even if the area of the third electrode differs in each cell.

The structure of the present invention can be applied not only to a normal three-electrode type PDP which performs the discharge between a pair of a first electrode and a second electrode, but also to a so-called ALIS PDP disclosed in Japanese Patent No. 2801893 (Patent Document 4). When the present invention is applied to a normal three-electrode type PDP, the third (Z) electrode is disposed between a pair of a first bus electrode and a second bus electrode to which the first discharge electrode and the second discharge electrode for performing discharge are connected. When the present invention is applied to an ALIS PDP, the third (Z) electrode is disposed between every first bus electrode and every second bus electrode, and the third (Z) electrodes are divided into four groups depending on the positions of disposition, and a common voltage is applied to each group.

According to the present invention, while maintaining the luminous uniformity of the cells, a start of a sustain discharge is varied in each cell so as to distribute the discharge current. Accordingly, it is possible to achieve a plasma display panel with high display quality that can be driven by a driving circuit with small driving capability. Also, when this plasma display panel is used to manufacture a plasma display device, its driving circuit can be configured with components with small driving capability. Therefore, it is possible to achieve the cost reduction.

### BRIEF DESCRIPTIONS OF THE DRAWINGS

FIG. 1 is a drawing showing the entire structure of a PDP device according to a first embodiment of the present invention;

FIG. 2 is an exploded perspective view of a PDP according to the first embodiment;

FIG. 3A is a cross-sectional view of the PDP according to the first embodiment;

FIG. 3B is a cross-sectional view of the PDP according to the first embodiment;

FIG. 4A is a drawing showing an electrode shape according to the first embodiment;

FIG. 4B is a drawing showing an electrode shape according to the first embodiment;

FIG. 4C is a drawing showing an electrode shape according to the first embodiment;

FIG. 4D is a drawing showing an electrode shape according to the first embodiment;

FIG. 5. is a drawing showing driving waveforms according to the first embodiment;

FIG. 6A is a drawing showing a change in wall charges according to the first embodiment;

FIG. 6B is a drawing showing a change in wall charges according to the first embodiment;

FIG. 6C is a drawing showing a change in wall charges according to the first embodiment;

FIG. 6D is a drawing showing a change in wall charges according to the first embodiment;

FIG. 6E is a drawing showing a change in wall charges according to the first embodiment;

FIG. 6F is a drawing showing a change in wall charges according to the first embodiment;

FIG. 6G is a drawing showing a change in wall charges according to the first embodiment;

FIG. 7A is a drawing used for the comparison of electric discharge according to the first embodiment with a conventional technology;

FIG. 7B is a drawing used for the comparison of electric discharge according to the first embodiment with a conventional technology;

FIG. 8 is a drawing showing a Paschen curve;

FIG. 9 is a drawing showing a modification example of the electrode structure;

FIG. 10A is a drawing showing a modification example of the electrode shape;

FIG. 10B is a drawing showing a modification example of the electrode shape;

FIG. 10C is a drawing showing a modification example of the electrode shape;

FIG. 10D is a drawing showing a modification example of the electrode shape;

FIG. 11A is a drawing showing a modification example of the electrode shape;

FIG. 11B is a drawing showing a modification example of the electrode shape;

FIG. 11C is a drawing showing a modification example of the electrode shape;

FIG. 11D is a drawing showing a modification example of the electrode shape;

FIG. 12A is a drawing showing a modification example of the electrode shape;

FIG. 12B is a drawing showing a modification example of the electrode shape;

FIG. 13 is a drawing showing the entire structure of a PDP device according to a second embodiment of the present invention;

FIG. 14A is a drawing showing an electrode shape according to the second embodiment;

FIG. 14B is a drawing showing an electrode shape according to the second embodiment;

FIG. 14C is a drawing showing an electrode shape according to the second embodiment;

FIG. 14D is a drawing showing an electrode shape according to the second embodiment;

FIG. 15 is a drawing showing driving waveforms (odd-number field) according to the second embodiment; and

FIG. 16 is a drawing showing driving waveforms (even-number field) according to the second embodiment.

### DESCRIPTIONS OF THE PREFERRED EMBODIMENTS

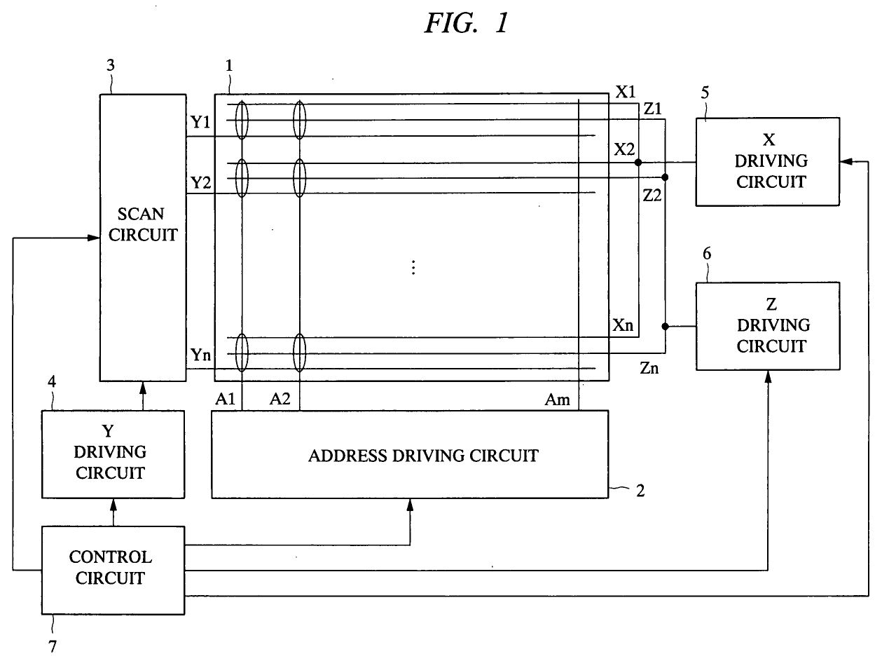

FIG. 1 is a diagram showing the entire structure of a plasma display device (PDP device) of a first embodiment of the present invention. A PDP 1 used in the PDP device of the first embodiment is obtained by applying the present invention to a conventional PDP in which a discharge is performed between a pair of a first (X) electrode and a second (Y) electrode. As shown in FIG. 1, in the PDP 1 of the first embodiment, laterally extending X electrodes X1, X2, . . . , Xn and Y electrodes Y1,. Y2, . . . , Yn are alternately disposed, and each of third electrodes Z1, Z2, . . . , Zn is disposed between the X electrode and the Y electrode of each pair. Therefore, n sets of three electrodes, that is, the X electrode, the Y electrode, and the Z electrode are formed. In addition, vertically extending fourth (address) electrodes A1, A2, . . . , Am are disposed so as to intersect with the n sets of the X electrodes, the Y electrodes, and the Z electrodes, and cells are formed at the intersecting parts. Therefore, n display rows and m display columns are formed.

As shown in FIG. 1, the PDP device of the first embodiment has an address driving circuit 2 which drives the m lines of address electrodes, a scanning circuit 3 which applies scan pulses to the n lines of Y electrodes, a Y driving circuit 4 which applies voltages other than the scanning pulses to the n lines of Y electrodes in common via the scanning circuit 3, an X driving circuit 5 which applies voltages to the n lines of X electrodes in common, a Z driving circuit 6 which applies voltages to the n lines of Z electrodes in common, and a control circuit 7 which controls each of the circuits. The PDP device of the first embodiment is different from the conventional examples in that the Z electrodes are provided in the PDP 1, and the Z driving circuit 6 which drives them is provided, and other parts are the same as the conventional examples. Therefore, only the parts relating to the Z electrodes will be described here, and descriptions of other parts will be omitted.

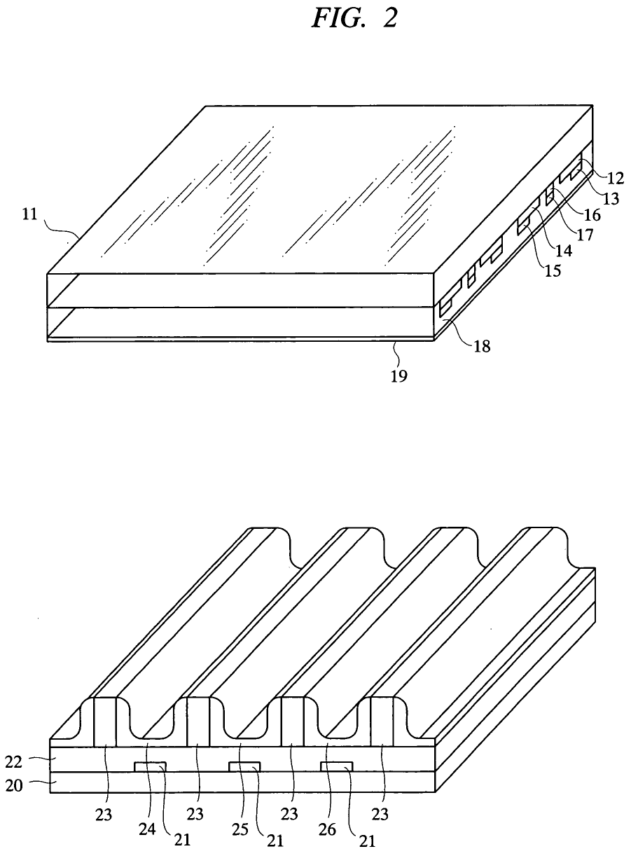

FIG. 2 is an exploded perspective view of the PDP of the first embodiment. As shown in FIG. 2, on a front (first) glass substrate 11, laterally extending first (X) bus electrodes 13 and second (Y) bus electrodes 15 are alternately disposed in parallel to each other so as to form pairs. X and Y optically transparent electrodes (discharge electrodes) 12 and 14 are provided so as to be overlapped over the X and Y bus electrodes 13 and 15, and parts of the X and Y discharge electrodes 12 and 14 are extending toward the side of the opposing electrodes. A third (Z) discharge electrode 16 and a third (Z) bus electrode 17 overlapped with each other are provided between the X and Y bus electrodes 13 and 15 of each pair. For example, the bus electrodes 13, 15, and 17 are formed of metal layers and the discharge electrodes 12, 14, and 16 are formed of ITO films or the like, and the resistance values of the bus electrodes 13, 15, and 17 are lower than or equal to the resistance values of the discharge electrodes 12, 14, and 16. Hereinafter, the parts of the X and Y discharge electrodes 12 and 14 extending from the X and Y bus electrodes 13 and 15 will be simply referred to as X and Y discharge electrodes 12 and 14, respectively, and the third (Z) discharge electrode 16 and the third (Z) bus electrode 17 will be together referred to as a third (Z) electrode.

On the discharge electrodes 12, 14, and 16 and the bus electrodes 13, 15, and 17, a dielectric layer 18 is formed so as to cover the electrodes. The dielectric layer 18 is made of a SiO₂ film or the like which allows visible light to pass and is formed through vapor-phase deposition, and it has a thickness of 10 μm or smaller. In the conventional technology, the dielectric layer has a thickness of 30 μm or larger in general. With such a thickness, however, the space between electrodes is close to the thickness of the dielectric layer, and therefore, the electric field strength in the discharge space for performing discharge cannot be increased. For example, in the case where the thickness of the dielectric layer is about 30 μm, even when the space between electrodes is made narrower than about 50 μm, an effect of reducing a firing voltage or the like cannot be achieved. Therefore, in consideration of the case where the space between electrodes is reduced as narrow as about 30 μm, the thickness of the dielectric layer is preferably about 10 μm or smaller, and such a dielectric layer can be formed through vapor-phase deposition.

Furthermore, a protective layer 19 of MgO or the like is formed on the dielectric layer 18. The protective layer 19 has effects of reducing discharge voltages, reducing discharge delay, and others by emitting electrons through ion bombardment to accelerate discharges. Since all of the electrodes are covered with the protective layer 19 in this structure, discharges utilizing the effects of the protective layer can be performed regardless which electrode group becomes a cathode. The glass substrate 11 having the above-described structure is utilized as a front substrate, and display is seen through the glass substrate 11.

Meanwhile, fourth (address) electrodes 21 are provided on a rear (second) substrate 20 so as to intersect with the bus electrodes 13, 15, and 17. For example, the address electrodes 21 are formed of metal layers. On the group of the address electrodes, a dielectric layer 22 is formed, and vertical barrier ribs 23 are formed on the dielectric layer 22. In addition, phosphor layers 24, 25, and 26 which emit visible light of red, green, and blue when excited by the ultraviolet rays generated upon discharges are coated on the side surfaces and bottom surfaces of the grooves formed by the barrier ribs 23 and the dielectric layer 22.

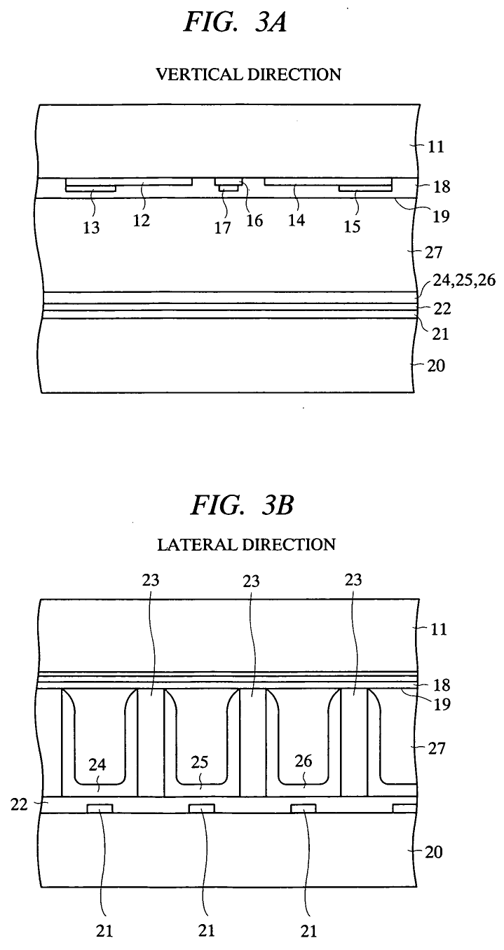

FIG. 3A and FIG. 3B are partial cross-sectional views of the PDP 1 of the first embodiment, wherein FIG. 3A is a vertical cross-sectional view, and FIG. 3B is a lateral cross-sectional view. Discharge gases such as Ne, Xe, and He are enclosed in discharge spaces 27 between the front substrate 11 and the rear substrate 20, which are divided by the barrier ribs 23. Gas pressure is within a range of approximately 5.3×10⁴ to 6.7×10⁴ Pa.

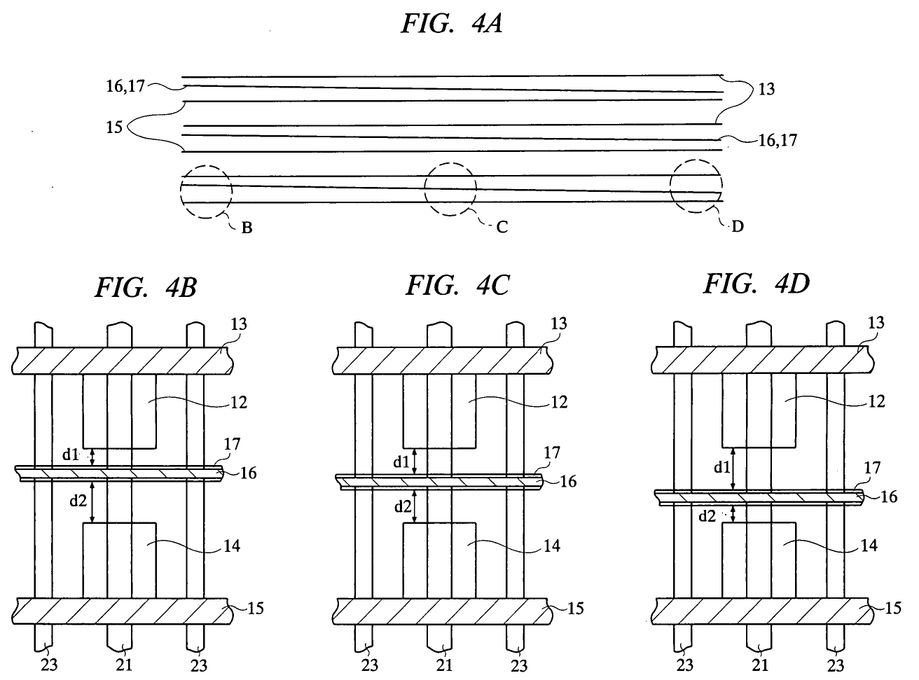

FIG. 4A to FIG. 4D are drawings each showing an electrode shape in the plasma display panel 1 according to the first embodiment. FIG. 4A is a drawing showing a layout of the X bus electrode 13, the Y bus electrode 15, and the Z electrodes 16 and 17 over the entire panel width in the first substrate 11, and FIG. 4B to FIG. 4D are drawings each showing an electrode shape in a cell at positions B to D in FIG. 4A.

As shown in FIG. 4A, the X bus electrodes 13 and the Y bus electrodes 15 extending in the same direction in parallel to one another are alternately disposed, and the Z electrodes (Z bus electrode and Z discharge electrode) 16 and 17 extending linearly are disposed between a pair of the X bus electrodes 13 and the Y bus electrodes 15 so as to form a predetermined angle with the X bus electrode 13 and the Y bus electrode 15. Since the X bus electrode 13, the Y bus electrode 15, and the Z electrodes 16 and 17 have a length of several tens of cm or more and a space between the X bus electrode 13 and the Y bus electrode 15 is several hundreds of μm, the angle formed between the Z electrodes 16 and 17 and the X bus electrode 13 and the Y bus electrode 15 is extremely small.

As shown in FIG. 4B to FIG. 4D, in each cell, the X bus electrodes 13 and the Y bus electrodes 15 are disposed in parallel to one another, and the barrier ribs 23 extending in a direction perpendicular to the X bus electrodes 13 and the Y bus electrodes 15 are disposed. In each portion divided by the barrier ribs 23, the X discharge electrode 12 extending from the X bus electrode 13 and the Y discharge electrode 14 extending from the Y bus electrode 15 are provided. Between the barrier ribs 23, the address electrode 21 is disposed so as to be overlapped on the X discharge electrode 12 and the Y discharge electrode 14. The X discharge electrode 12 and the Y discharge electrode 14 have approximately the same shape, and their edges opposing to each other are parallel to the extending direction of the bus electrodes 13 and 15.

Between the X discharge electrode 12 and the Y discharge electrode 14, the third (Z) bus electrode 16 and the third (Z) discharge electrode 17 are provided. The Z bus electrode 16 and the Z discharge electrode 17 have approximately the same width, and are provided so as to be approximately overlapped with each other. The Z discharge electrode 17 is provided so as to improve the adherence of the Z bus electrode 16 made of a metal layer to the glass substrate 11 and is not necessarily required. Also, the Z discharge electrode 17 has a width approximately the same as that of the Z bus electrode 16 and little contributes to the discharge. As shown in FIG. 4A, the Z bus electrode 16 and the Z discharge electrode 17 (Z electrodes) form a predetermined angle with the X bus electrode 13 and the Y bus electrode 15. Thus, in a cell at a position B on the left of the panel, as shown in FIG. 4B, a space d1 between the Z electrodes 16 and 17 and the X discharge electrode 12 is narrow, and a space d2 between the Z electrodes 16 and 17 and the Y discharge electrode 14 is wide. Similarly, in a cell at a position C at the center of the panel, as shown in FIG. 4C, the space d1 between the Z electrodes 16 and 17 and the X discharge electrode 12 is equal to the space d2 between the Z electrodes 16 and 17 and the Y discharge electrode 14. Further, in a cell at a position D on the right of the panel, as shown in FIG. 4D, the space d1 between the Z electrodes 16 and 17 and the X discharge electrode 12 is wide, and the space d2 between the Z electrodes 16 and 17 and the Y discharge electrode 14 is narrow. Accordingly, in the cell at the position B on the left of the panel, the firing voltage between the Z electrodes 16 and 17 and the X discharge electrode 12 is low, and the firing voltage between the Z electrodes 16 and 17 and the Y discharge electrode 14 is high. In the cell at the position D on the right of the panel, the firing voltage between the Z electrodes 16 and 17 and the X discharge electrode 12 is high, and the firing voltage between the Z electrodes 16 and 17 and the Y discharge electrode 14 is low. In the cell at the position C at the center of the panel, the firing voltage between the Z electrodes 16 and 17 and the X discharge electrode 12 is equal to the firing voltage between the Z electrodes 16 and 17 and the Y discharge electrode 14, and the firing voltage takes a mean value between the above-described ones.

Next, operations of the PDP device of the first embodiment will be described. In each cell of the PDP, only On/Off can be selected, and lighting luminance cannot be changed, i.e., grayscale display cannot be performed. Therefore, one frame is divided into a plurality of predetermined weighted sub-fields, and grayscale display is performed for each cell by combining the lighting sub-fields in one frame. The sub-fields normally have the same driving sequence.

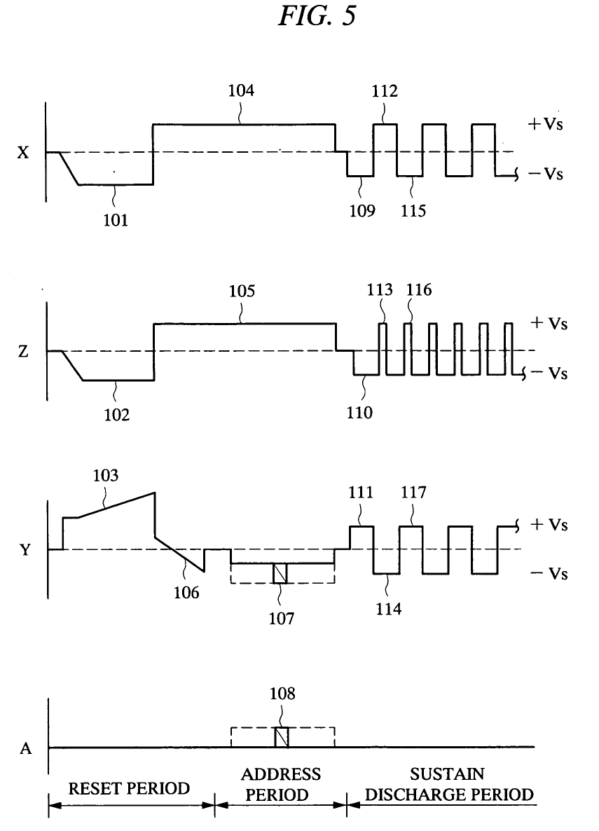

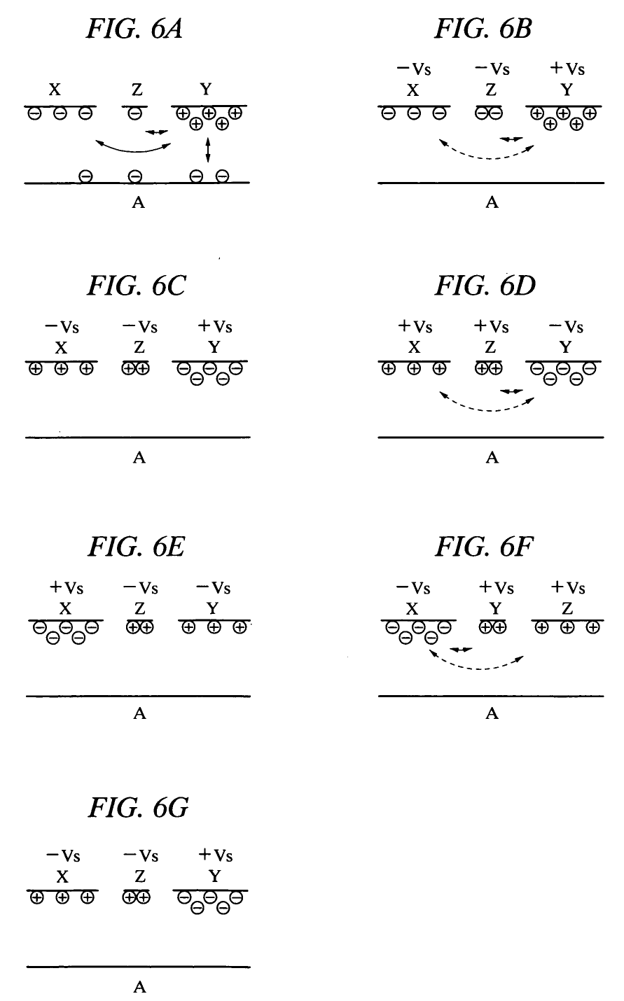

FIG. 5 is a drawing showing driving waveforms in one sub-field in the PDP device according to the first embodiment, and FIG. 6A to FIG. 6G are drawings showing a change in the wall charge according to the first embodiment.

At the beginning of a reset period, in a state where 0 V is applied to address electrodes A, negative reset pulses 101 and 102 in which a voltage is gradually lowered to reach a constant value are applied to the X electrode and the Z electrode, and a positive reset pulse 103 in which a predetermined voltage is applied and then the voltage gradually increases is applied to the Y electrode. By doing so, in all the cells, discharges are generated between the Z discharge electrodes 16 and 17 the Y discharge electrode 14 at first, and the discharge is shifted to the discharges between the X discharge electrode 12 and the Y discharge electrode 14. Since the pulses applied here are obtuse waves in which the voltages are gradually changed, slight discharges and charge formation are repeated, and wall charge is formed uniformly in all cells. The polarity of the formed wall charge is the positive polarity near the X discharge electrode and the Z discharge electrode and is the negative polarity near the Y discharge electrode.

Then, positive compensation voltages 104 and 105 (for example, +Vs) are applied to the X discharge electrodes and the Z discharge electrodes, and a compensation obtuse wave 106 in which the voltage gradually decreases is applied to the Y electrodes. By doing so, since the voltage of the polarity opposite to that of the wall charge which has been formed in the above-described manner is applied in the obtuse wave, wall charge in the cells is reduced through slight discharges. In the above-described manner, the reset period is completed, and all cells are brought into a uniform state.

In the PDP according to the present embodiment, since the Z electrodes 16 and 17 are provided, the space between the Z electrodes 16 and 17 and the Y discharge electrode 14 is narrow, and therefore a discharge occurs even by a low firing voltage, which triggers a shift to the discharge between the X discharge electrode 12 and the Y discharge electrode 14. Therefore, a reset voltage to be applied between the X and Z electrodes and the Y electrode can be made small. Thus, the amount of light emitted through the reset discharges which are not involved in display can be reduced, thereby improving the contrast.

In a subsequent address period, the voltage (for example, +Vs) which is the same as the compensation voltages 104 and 105 is applied to the X electrode and the Z electrode, and a predetermined negative voltage is applied to the Y electrodes. In this state, a scan pulse 107 is further sequentially applied to the Y electrodes. In accordance with the application of the scan pulse 107, an address pulse 108 is applied to the address electrodes of the cells to be turned on. Consequently, as shown in FIG. 6A, discharges are generated between the Y electrode to which the scan pulse is applied and the address electrode to which the address pulse is applied, and these discharges trigger the generation of discharges between the X and Z electrodes and the Y discharge electrodes. Through these address discharges, as shown in FIG. 6B, negative wall charge is formed near the X electrodes and the Z electrodes (on the surface of the dielectric layer), and positive wall charge is formed near the Y electrodes. Since the area of the Z electrode is small in comparison with the area of the X electrode, the amount of wall charges formed near the Z electrode is smaller than the amount of wall charges formed near the X electrode. In this case, the positive wall charge formed near the Y electrode corresponds to the amount of the wall charge of the total negative wall charges formed near the X electrode and the Z electrode. In the cells to which the scan pulse or the address pulse is not applied, the wall charge at the time of the reset is maintained since the address discharge is not generated. In the address period, the scan pulse is sequentially applied to all of the Y electrodes to carry out the above-described operations, and address discharges are generated in all cells to be turned on in the entire panel surface.

Note that, at the end of the address period, in the cells in which the address discharges are not generated, a pulse for adjusting the wall charge which has been formed in the reset period is applied in some cases.

In the sustain discharge period, first, negative sustain discharge pulses 109 and 110 of a voltage −Vs are applied to the X electrode and the Z electrode, respectively, and a positive sustain discharge pulse 111 of a voltage +Vs is applied to the Y electrode. As shown in FIG. 6B, in the cells in which an address discharge has been performed, a voltage by the positive wall charges formed near the Y electrode is superposed on the voltage +Vs, and a voltage by the negative wall charges formed near the X electrode and the Z electrode is superposed on the voltage −Vs. Consequently, a discharge first starts between the Z electrode and the Y electrode where the space therebetween is narrow, and this discharge triggers a shift to a discharge between the X electrode and the Y electrode where the space therebetween is wide. The discharge between the X electrode and the Y electrode is a long-distance discharge, which is a discharge exhibiting good light emission efficiency. This discharge is converged when positive charges of the charges generated by the discharge are accumulated near the X electrode and the Z electrode as the wall charges, negative charges of the charges generated by the discharge are accumulated near the Y electrode as the wall charges, and the voltage by the wall charges decreases the voltage between the X and Z electrodes and the Y electrode. At the time of the convergence, as shown in FIG. 6C, positive wall charges are formed near the X electrode and the Z electrode, and negative wall charges are formed near the Y electrode. Note that, in the cells in which no address discharge has been performed, such a discharge as described above does not occur, and a discharge does not occur during the sustain discharge period, and therefore, the description thereof will be omitted. Also, in the present embodiment, since the space between the Z electrodes 16 and 17 and the X discharge electrode 12 and the Y discharge electrode 14 is varied on the left, center, and right of the panel, there is a difference in discharge start, which will be described below.

Next, as shown in FIG. 5, a positive sustain discharge pulse 112 of a voltage +Vs is applied to the X electrode, a negative sustain discharge pulse 114 of a voltage −Vs is applied to the Y electrode, and a pulse 113 changed to a voltage +Vs and then to a voltage −Vs in a short time is applied to the Z electrode. By doing so, as shown in FIG. 6D, a voltage by the negative wall charges formed near the Y electrode is superposed on the voltage −Vs, and a voltage by the positive wall charges formed near the X electrode and the Z electrode is superposed on the voltage +Vs. Accordingly, a discharge first starts between the Z electrode and the Y electrode, which triggers a shift to a discharge between the X electrode and the Y electrode where the space therebetween is wide. Immediately thereafter, the voltage applied to the Z electrode is changed from +Vs to −Vs, and the discharge between the Z electrode and the Y electrode is stopped. The discharge between the X electrode and the Y electrode is stopped when negative charges are accumulated near the X electrode as the wall charge and positive charges are accumulated near the Y electrode as the wall charge. At this time, since −Vs is applied to the Z electrode, positive wall charges are formed near the Z electrode. Therefore, at the time of convergence, as shown in FIG. 6E, negative wall charges are formed near the X electrode, and positive wall charges are formed near the Y electrode and the Z electrode.

Next, as shown in FIG. 5, a negative sustain discharge pulse 115 of a voltage −Vs is applied to the X electrode, a positive sustain discharge pulse 117 of a voltage +Vs is applied to the Y electrode, and a pulse 116 changed to a voltage +Vs and then to a voltage −Vs in a short time is applied to the Z electrode. By doing so, as shown in FIG. 6F, a voltage by the negative wall charges formed near the X electrode is superposed on the voltage −Vs, and a voltage by the positive wall charges formed near the Y electrode and the Z electrode is superposed on the voltage +Vs. Accordingly, a discharge first starts between the Z electrode and the X electrode, which triggers a shift to a discharge between the X electrode and the Y electrode where the space therebetween is wide. Immediately thereafter, the voltage applied to the Z electrode is changed from +Vs to −Vs, and the discharge between the Z electrode and the X electrode is stopped. At this time, since −Vs is applied to the Z electrode, positive wall charges are formed near the Z electrode. Therefore, at the time of the convergence, as shown in FIG. 6G, positive wall charges are formed near the X electrode and the Z electrode, and negative wall charges are formed near the Y electrode. More specifically, the state returns to the state shown in FIG. 6C. Thereafter, positive and negative sustain discharge pulses are alternately applied to the X electrode and the Y electrode, and a pulse with a narrow width is applied to the Z electrode in synchronization with the application of the sustain discharge pulse. By doing so, the operations in FIG. 6C to FIG. 6G are repeated to repeat the sustain discharge.

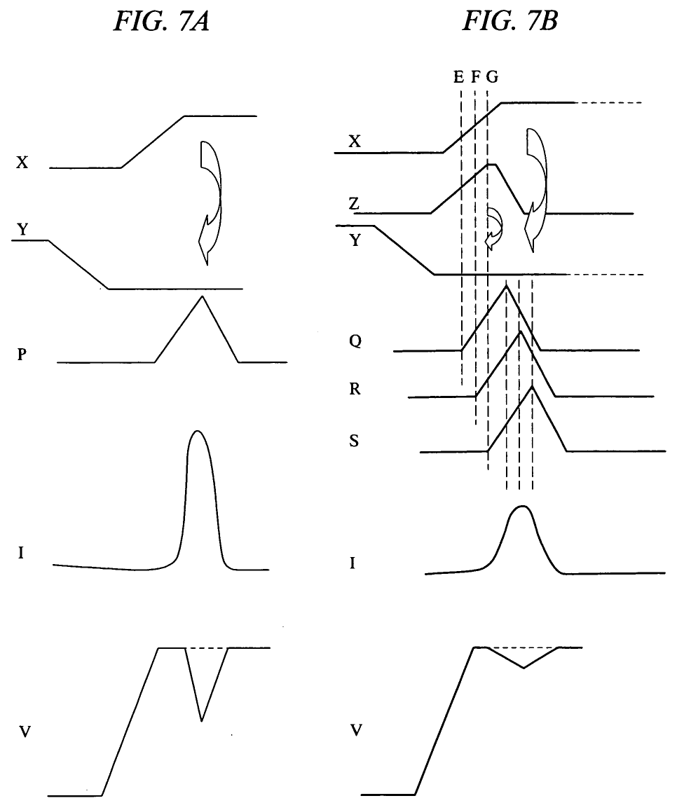

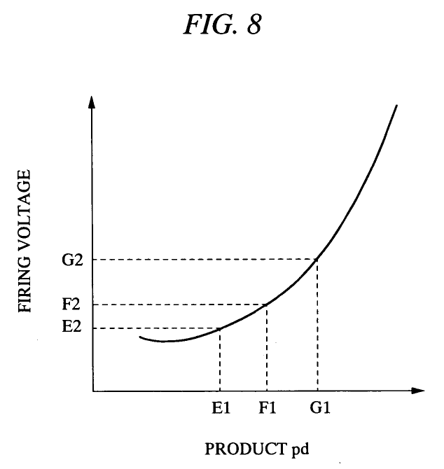

Next, effects achieved from variations in space between the Z electrodes 16 and 17 and the X and Y discharge electrodes 12 and 14 in the cells on the left, center, and right of the panel will be described with reference to FIG. 7A, FIG. 7B, and FIG. 8. FIG. 7A shows a state where a sustain discharge is generated between the X discharge electrode and the Y discharge electrode in the conventional structure where no Z electrode is provided and the space between the opposing edges is the same among all cells. FIG. 7B shows a state where a sustain discharge is generated between the X and Z discharge electrodes and the Y discharge electrode in the structure of the present embodiment. Also, FIG. 8 shows a Paschen curve.

In the conventional structure, a space d between the opposing edges of the X discharge electrode and the Y discharge electrode is the same among all cells, and a gas pressure p is the same among all cells. Therefore, the product (pd) of the gas pressure and the space is the same among all cells. Accordingly, in the Paschen curve of FIG. 8, the product pd has one value, and the firing voltage is the same among all cells. Thus, as shown in FIG. 7A, a sustain discharge P between the X discharge electrode and the Y discharge electrode starts at the same timing among all cells, and the intensity of the discharge is also increased similarly. Therefore, a current I supplied from the X driving circuit and the Y driving circuit is abruptly increased at the peak of the discharge. Since this abruptly-increasing current I flows through the X electrode and the Y electrode, the voltage V applied to the end of each of the X electrode and the Y electrode is temporarily reduced significantly due to the voltage drop. As a result, problems that the discharge intensity is reduced and a discharge cannot be normally performed in part of the cells occur.

On the other hand, in the PDP 1 according to the first embodiment, the space d1 between the opposing edges of the Z electrode and the X discharge electrode is the narrowest in the cell on the left of the panel, and it is gradually increased and becomes the widest in the cell on the right. Also, the space d2 between the opposing edges of the Z electrode and the Y discharge electrode is the widest in the cell on the left of the panel, and it is gradually decreased and becomes the narrowest in the cell on the right. Since the gas pressure p is the same among all cells, the product (pdl) of the space d1 between the opposing edges of the Z electrode and the X discharge electrode and the gas pressure is represented in FIG. 8 by, for example, a point E1 for the cell on the left, a point F1 for the cell at the center, and a point G1 for the cell on the right, and their firing voltages are represented by points E2, F2, and G2, respectively. Conversely, the product (pd2) of the space d2 between the opposing edges of the Z electrode and the Y discharge electrode and the gas pressure is represented in FIG. 8 by, for example, the point G1 for the cell on the left, the point F1 for the cell at the center, and the point E1 for the cell on the right, and their firing voltages are represented by the points G2, F2, and E2, respectively.

As shown in FIG. 7B, after the voltage applied to the Y electrode is decreased, the voltages applied to the Z electrode and the X electrode are increased. In this case, the voltage applied to the Z electrode rises slightly earlier than the voltage applied to the X electrode. With the increase of the voltage applied to the Z electrode, first at the time of E, the voltage between the Z electrode and the Y discharge electrode in the cell on the right exceeds the firing voltage E2, and a trigger discharge between the Z electrode and the Y discharge electrode is started. Furthermore, at the time of F, the voltage between the Z electrode and the Y discharge electrode in the cell at the center exceeds the firing voltage F2, and a trigger discharge is started. Also, at the time of G, the voltage between the Z electrode and the Y discharge electrode in the cell on the left exceeds the firing voltage G2, and a trigger discharge is started. As described above, trigger-discharge start timing is varied depending on the position of the cell on the panel. In other words, a trigger discharge starts in the order of the cells from right to left on the panel. In practice, this time difference is extremely small and cannot be distinguished by the human eyes.

As the trigger discharge starts between the Z electrode and the Y discharge electrode, main discharges Q, R, and S also start between the X discharge electrode and the Y discharge electrode in the cells on the right, center, and left, respectively, on the panel. However, since their trigger timings are different from one another, the timings of the main discharges Q, R, and S are also different from one another. Therefore, the discharge intensity of the main discharge Q in the cell on the right of the panel first reaches its peak value, then the discharge intensity of the main discharge R in the cell at the center on the panel reaches its peak value, and finally the discharge intensity of the main discharge S in the cell on the left of the panel reaches its peak value. Note that the voltage applied to the Z electrode is decreased before the discharge intensity of the main discharge Q in the cell on the right of the panel reaches its peak value.

As described above, the sustain discharges Q, R, and S between the X discharge electrode and the Y discharge electrode start at different timings, and also, the timings when the discharge intensity reaches the peak value are different. Therefore, since the peaks in discharge are not concentrated, the current I supplied from the X driving circuit and the Y driving circuit is not much abruptly increased. Accordingly, the current I flowing through the X electrode and the Y electrode is also distributed, and therefore, the amount of voltage drop of the voltage V applied to the end of each of the X electrode and the Y electrode is reduced.

In FIG. 7B, the case where the voltage applied to the Z electrode is changed in the same manner as the voltage applied to the X electrode to generate a trigger discharge between the Z electrode and the Y discharge electrode has been described. The same goes for the case where a trigger discharge is generated between the Z electrode and the X discharge electrode. In this case, a trigger discharge starts from the cell on the left of the panel.

The first embodiment of the present invention has been described above. However, there are various modification examples of the structure and shape of the electrodes. Some of such modification examples will be described below.

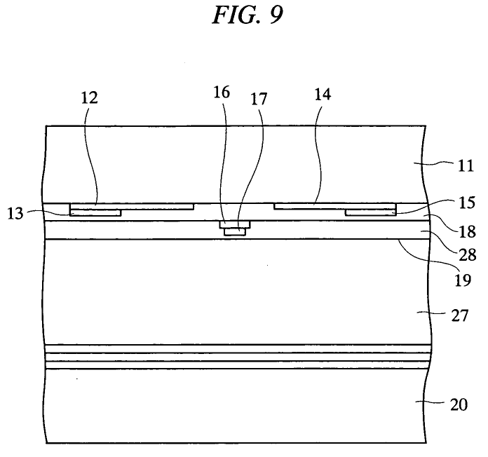

FIG. 9 is a diagram showing a modification example of the electrode structures. In the first embodiment, as shown in FIG. 3A, the Z electrode (Z discharge electrode 16 and Z bus electrode 17) is formed in the same layer as the X electrode (X discharge electrode 12 and X bus electrode 13) and the Y electrode (Y discharge electrode 14 and Y bus electrode 15). In such a case, the Z electrode can be formed in the same process as the X electrode and the Y electrode, and new processes for providing the Z electrodes are not required to be added. However, since the Z electrode is provided between the X discharge electrode 12 and the Y discharge electrode 14, there is a problem that, due to variations in the positions and line widths in fabrication, the Z electrode is short-circuited with the X discharge electrode 12 and the Y discharge electrode 14 and the yield is lowered. Therefore, in the modification example of FIG. 9, the Z electrode (Z discharge electrode 16 and Z bus electrode 17) is formed on the dielectric layer 18 covering the X electrode (X discharge electrode 12 and X bus electrode 13) and the Y electrode (Y discharge electrode 14 and Y bus electrode 15), and the dielectric layer and the Z electrode are covered with a dielectric layer 28. Also in this structure, the same operation as the first embodiment can be carried out.

Although the modification example of FIG. 9 has a problem that the manufacturing cost is increased in comparison with the first embodiment since the process for providing the Z electrode is added. However, the Z electrode is not short-circuited with the X discharge electrode 12 and the Y discharge electrode 14 since the Z electrode is formed in the layer different from that of the X electrode and the Y electrode, and the reduction in yield due to short circuit can be prevented. Moreover, since they are provided in different layers, when viewed from above the substrate, the distances between the Z electrode and the X discharge electrode 12 and between the Z electrode and the Y discharge electrode 14 can be significantly reduced.

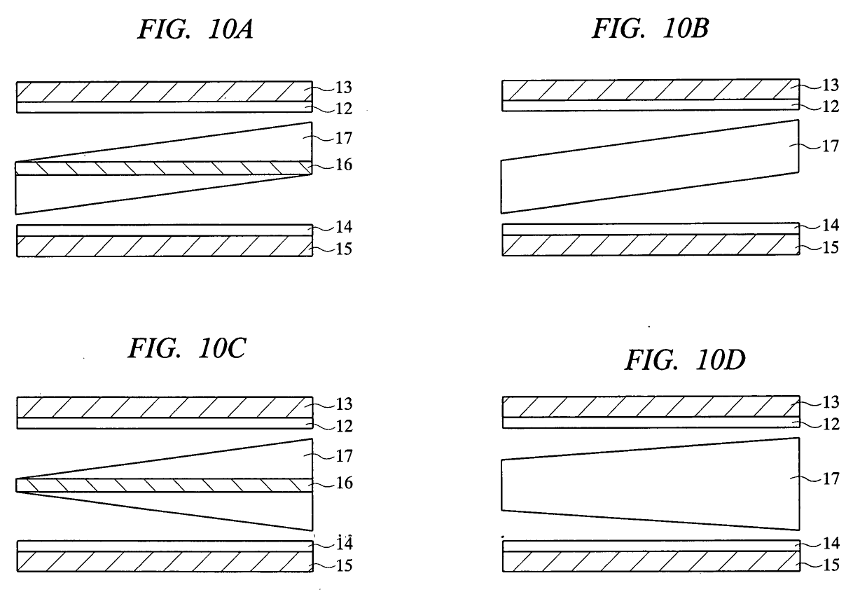

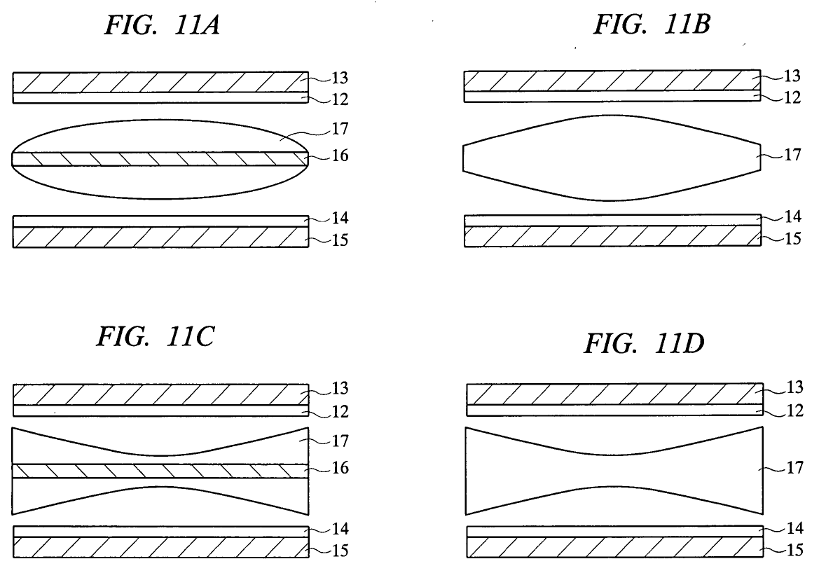

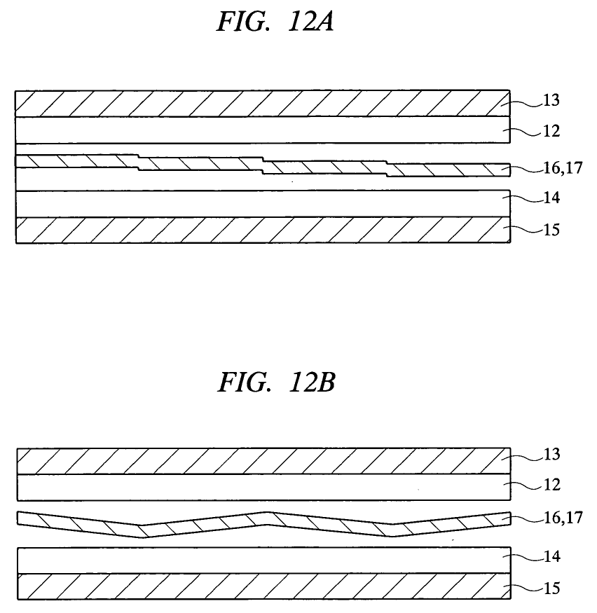

FIG. 10A to FIG. 10D, FIG. 11A to FIG. 11D, and FIG. 12A and FIG. 12B are drawings schematically showing the modification examples of the electrode shape in which the relation on the entire width of the panel among the X discharge electrode 12, the X bus electrode 13, the Y discharge electrode 14, the Y bus electrode 15, the Z bus electrode 16, and the Z discharge electrode 17 is described. In any examples, the X discharge electrode 12, the X bus electrode 13, the Y discharge electrode 14, and the Y bus electrode 15 are shown as electrodes having the same width. However, similar to the first embodiment of FIG. 4A to FIG. 4D, the X discharge electrode 12 and the Y discharge electrode 14 may have portions protruding from the X bus electrode 13 and the Y bus electrode 15 for each cell.

In FIG. 10A, the Z bus electrode 16 has a linear shape having a constant width in parallel to the X bus electrode 13 and the Y bus electrode 15 and is disposed in the middle of the X bus electrode 13 and the Y bus electrode is. The Z discharge electrode 17 has a parallelogram shape, and the edges of the Z discharge electrode 17 opposing to the X discharge electrode 12 and the Y discharge electrode 14 form a predetermined angle with respect to the X bus electrode 13 and the Y bus electrode 15. Therefore, on the left side, a space between the Z discharge electrode 17 and the X bus electrode 13 (X discharge electrode 12) is wide and a space between the Z discharge electrode 17 and the Y bus electrode 15 (Y discharge electrode 14) is narrow. On the right side, the space between the Z discharge electrode 17 and the X bus electrode 13 (X discharge electrode 12) is narrow and the space between the Z discharge electrode 17 and the Y bus electrode 15 (Y discharge electrode 14) is wide. Accordingly, similar to the first embodiment, the driving current can be distributed without generating luminance nonuniformity.

FIG. 10B shows a structure of a modification example of FIG. 10A, in which no Z bus electrode 16 is provided. The Z electrode is to generate a trigger discharge and little contributes to main discharge. Therefore, the current flowing through the Z electrode may be small, and any problem does not occur even when the bus electrode is not provided.

In FIG. 10C, the Z bus electrode 16 has a linear shape having a constant width in parallel to the X bus electrode 13 and the Y bus electrode 15 and is disposed in the middle of the X bus electrode 13 and the Y bus electrode 15. The Z discharge electrode 17 has a trapezoid shape, and the edges of the Z discharge electrode 17 opposing to the X discharge electrode 12 and the Y discharge electrode 14 form a predetermined angle with respect to the X bus electrode 13 and the Y bus electrode 15. Therefore, on the left side, a space between the Z discharge electrode 17 and the X bus electrode 13 (X discharge electrode 12) and a space between the Z discharge electrode 17 and the Y bus electrode 15 (Y discharge electrode 14) are wide. On the right side, the space between the Z discharge electrode 17 and the X bus electrode 13 (X discharge electrode 12) and the space between the Z discharge electrode 17 and the Y bus electrode 15 (Y discharge electrode 14) are narrow. Accordingly, similar to the first embodiment, the driving current can be distributed without generating luminance nonuniformity.

FIG. 10D shows a structure of a modification example of FIG. 10C, in which no Z bus electrode 16 is provided.

In FIG. 11A, the Z bus electrode 16 has a linear shape having a constant width in parallel to the X bus electrode 13 and the Y bus electrode 15, and it is disposed in the middle of the X bus electrode 13 and the Y bus electrode 15. The Z discharge electrode 17 has curved edges and its width is narrow at both ends and wide at the center. Therefore, on the right and left sides, a space between the Z discharge electrode 17 and the X bus electrode 13 (X discharge electrode 12) and a space between the Z discharge electrode 17 and the Y bus electrode 15 (Y discharge electrode 14) are wide. At the center, a space between the Z discharge electrode 17 and the X bus electrode 13 (X discharge electrode 12) and a space between the Z discharge electrode 17 and the Y bus electrode 15 (Y discharge electrode 14) are narrow. Accordingly, similar to the first embodiment, the driving current can be distributed without generating luminance nonuniformity.

FIG. 11B shows a structure of a modification example of FIG. 11A, in which no Z bus electrode 16 is provided.

In FIG. 11C, the Z bus electrode 16 has a linear shape having a constant width in parallel to the X bus electrode 13 and the Y bus electrode 15, and it is disposed in the middle of the X bus electrode 13 and the Y bus electrode 15. The Z discharge electrode 17 has curved edges and its width is wide at both ends and narrow at the center. Therefore, on the right and left sides, a space between the Z discharge electrode 17 and the X bus electrode 13 (X discharge electrode 12) and a space between the Z discharge electrode 17 and the Y bus electrode 15 (Y discharge electrode 14) are narrow. At the center, a space between the Z discharge electrode 17 and the X bus electrode 13 (X discharge electrode 12) and a space between the Z discharge electrode 17 and the Y bus electrode 15 (Y discharge electrode 14) are wide. Accordingly, similar to the first embodiment, the driving current can be distributed without generating luminance nonuniformity.

FIG. 11D shows a structure of a modification example of FIG. 11C, in which no Z bus electrode 16 is provided.

FIG. 12A shows a modification example of the electrode shape of the first embodiment shown in FIG. 4A to FIG. 4D, in which the Z bus electrode 16 and the Z discharge electrode 17 have edges parallel to the X bus electrode 13 and the Y bus electrode 15 and their disposing positions are changed stepwise. The Z bus electrode 16 and the Z discharge electrode 17 have a stepwise shape.

FIG. 12B shows a modification example of the electrode shape of the first embodiment shown in FIG. 4A to FIG. 4D, in which the Z bus electrode 16 and the Z discharge electrode 17 have a zigzag shape. In other words, in contrast to the first embodiment in which the Z bus electrode 16 and the Z discharge electrode 17 are tilted over the entire width of the panel, the Z bus electrode 16 and the Z discharge electrode 17 have a shape that the parts thereof are tilted alternately in opposite directions in each one-integer (in this case, one-fourth) of the entire width of the panel and are connected to each other.

The structure shown in FIG. 12B in which the shape of the Z electrode is varied in a cycle of one-integer of the entire width of the panel can be applied to the modification examples shown in FIG. 10A, FIG. 11A and FIG. 12A.

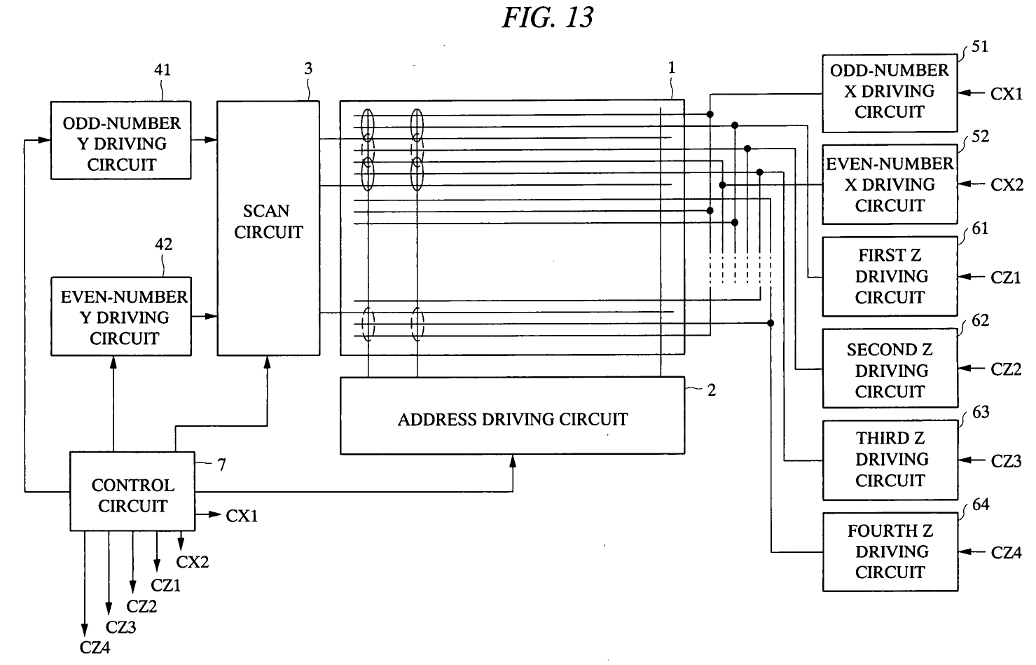

FIG. 13 is a diagram showing the entire structure of a PDP device of the second embodiment of the present invention. The second embodiment is an example in which the present invention is applied to an ALIS PDP device disclosed in Patent Document 4. In this example, in the structure including the first and second electrodes (X and Y electrodes) provided in a first substrate (transparent substrate) and the fourth electrode (address electrode) provided in a second electrode (rear substrate), the third (Z electrode) is provided between the X electrode and the Y electrode. Since the ALIS method is disclosed in Patent Document 4, detailed description thereof will be omitted here.

As shown in FIG. 13, the plasma display panel 1 has a plurality of laterally (longitudinally) extending first electrodes (X electrodes) and second electrodes (Y electrodes). The plurality of X electrodes and Y electrodes are alternately disposed, and the number of the lines of the X electrodes is larger than that of the Y electrodes by one. The third electrode (Z electrode) is disposed between the X electrode and the Y electrode. Therefore, the number of the lines of the Z electrodes is twice that of the Y electrodes. The fourth electrodes (address electrode) are extending in the direction perpendicular to the extending direction of the X, Y, and Z electrodes. In the ALIS method, all of the spaces between the X electrodes and the Y electrodes are utilized as display lines, and odd-numbered display lines and even-numbered display lines are subjected to interlaced display. In other words, the odd-number display lines are formed between the odd-numbered X electrodes and the odd-numbered Y electrodes and between the even-numbered X electrodes and even-numbered Y electrodes, and the even-number display lines are formed between the odd-numbered Y electrodes and the even-numbered X electrodes and between the even-numbered Y electrodes and the odd-numbered X electrodes. One display field is comprised of an odd-number field and an even-number field, wherein the odd-number display lines are displayed in the odd-number field, and the even-number display lines are displayed in the even-number field. Therefore, the Z electrodes are present in each of the odd-number and even-number display lines. In this case, the Z electrodes provided between the odd-numbered X electrodes and the odd-numbered Y electrodes are referred to as the Z electrodes of a first group, the Z electrodes provided between the odd-numbered Y electrodes and the even-numbered X electrodes are referred to as the Z electrodes of a second group, the Z electrodes provided between the even-numbered X electrodes and the even-numbered Y electrodes are referred to as the Z electrodes of a third group, and the Z electrodes provided between the even-numbered Y electrodes and the odd-numbered X electrodes are referred to as the Z electrodes of a fourth group. In other words, the 4p+1th (wherein p is a natural number) Z electrode is the Z electrode of the first group, the 4p+2th Z electrode is the Z electrode of the second group, the 4p+3th Z electrode is the Z electrode of the third group, and the 4p+4th Z electrode is the Z electrode of the fourth group.

As shown in FIG. 13, the PDP device of the second embodiment has the address driving circuit 2 which drives the address electrodes, the scanning circuit 3 which applies scan pulses to the Y electrodes, an odd-number Y driving circuit 41 which applies voltages other than the scan pulse to the odd-numbered Y electrodes in common via the scanning circuit 3, an even-number Y driving circuit 42 which applies voltages other than the scan pulse to the even-numbered Y electrodes in common via the scanning circuit 3, an odd-number X driving circuit 51 which applies voltages to the odd-numbered X electrodes in common, an even-number X driving circuit 52 which applies voltages to the even-numbered X electrodes in common, a first Z driving circuit 61 which drives the Z electrodes of the first group in common, a second Z driving circuit 62 which drives the Z electrodes of the second group in common, a third Z driving circuit 63 which drives the Z electrodes of the third group in common, a fourth Z driving circuit 64 which drives the Z electrodes of the fourth group in common, and the control circuit 7 which controls each of the circuits.

The PDP of the second embodiment has the same structure as the first embodiment except that the X discharge electrodes and the Y discharge electrodes are provided on both sides of the X bus electrodes and the Y bus electrodes, respectively, and the Z electrodes are provided between all of the X bus electrodes and the Y bus electrodes. Therefore, the exploded perspective view thereof will be omitted. Note that the Z electrodes can be formed in the same layer as the X and Y electrodes as shown in FIG. 3 or can be formed in the layer different from that of the X and Y electrodes as shown in FIG. 9.

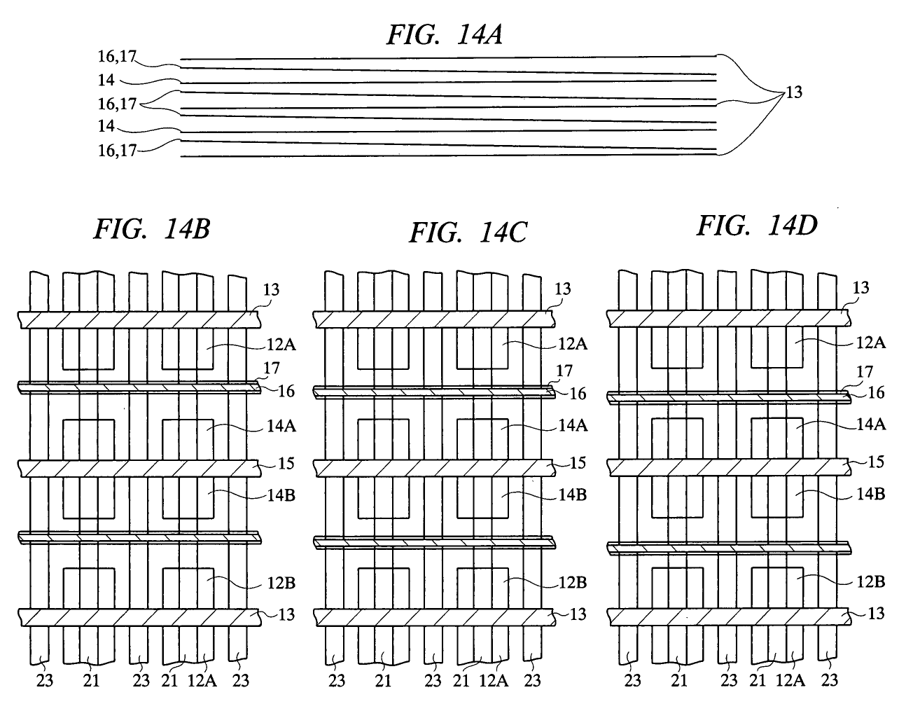

FIG. 14A to FIG. 14D are drawings each showing an electrode shape according to the second embodiment. FIG. 14A shows a layout of X bus electrodes 13, Y bus electrodes 15, and Z electrodes 16 and 17 over the entire width of the panel on the first substrate 11, and FIG. 14B to FIG. 14D show an electrode shape in a cell at each of the positions B to D.

As shown in the drawings, the equally-spaced X bus electrode 13 and the Y bus electrode 15 are disposed in parallel to each other, and the Z electrode 16 and 17 are disposed so as to form a predetermined angle at the center between them. The barrier ribs 23 extending in the direction perpendicular to the bus electrodes 13, 15, and 17 are disposed. The address electrode 21 is disposed between the barrier ribs 23. In each section divided by the barrier ribs 23, an X discharge electrode 12A which is downwardly extending from the X bus electrode 13, an X discharge electrode 12B which is upwardly extending from the X bus electrode 13, a Y discharge electrode 14A which is upwardly extending from the Y bus electrode 15, and a Y discharge electrode 14B which is downwardly extending from the Y bus electrode 15 are provided. The edges of the X discharge electrodes 12A and 12B opposing to the Z electrodes 16 and 17 are parallel to the extending direction of the X bus electrodes 13 and the Y bus electrode 15.

Similar to the first embodiment described above, the Z electrodes 16 and 17 are tilted toward the X bus electrode 13 and the Y bus electrode 15. Therefore, on the left of the panel, as shown in FIG. 14B, in a cell where the X discharge electrode 12A and the Y discharge electrode 14A are opposed to each other, a space between the Z electrodes 16 and 17 and the X discharge electrode 12A is narrow and a space between the Z electrodes 16 and 17 and the Y discharge electrode 14A is wide. Also, in a cell where the X discharge electrode 12B and the Y discharge electrode 14B are opposed to each other, a space between the Z electrodes 16 and 17 and the Y discharge electrode 14B is narrow and a space between the Z electrodes 16 and 17 and the X discharge electrode 12B is wide. Similarly, at the center of the panel, as shown in FIG. 14C, in both of a cell where the X discharge electrode 12A and the Y discharge electrode 14A are opposed to each other and a cell where the X discharge electrode 12B and the Y discharge electrode 14B are opposed to each other, a space between the Z electrodes 16 and 17 and the X discharge electrodes 12A and 12B and a space between the Z electrodes 16 and 17 and the Y discharge electrodes 14A and 14B are equal to each other. On the right of the panel, as shown in FIG. 14D, in a cell where the X discharge electrode 12A and the Y discharge electrode 14A are opposed to each other, a space between the Z electrodes 16 and 17 and the X discharge electrode 12A is wide and a space between the Z electrodes 16 and 17 and the Y discharge electrode 14A is narrow. Also, in a cell where the X discharge electrode 12B and the Y discharge electrode 14B are opposed to each other, a space between the Z electrodes 16 and 17 and the Y discharge electrode 14B is wide, and a space between the Z electrodes 16 and 17 and the X discharge electrode 12B is narrow. The firing voltage between electrodes is varied depending on the space between electrodes.

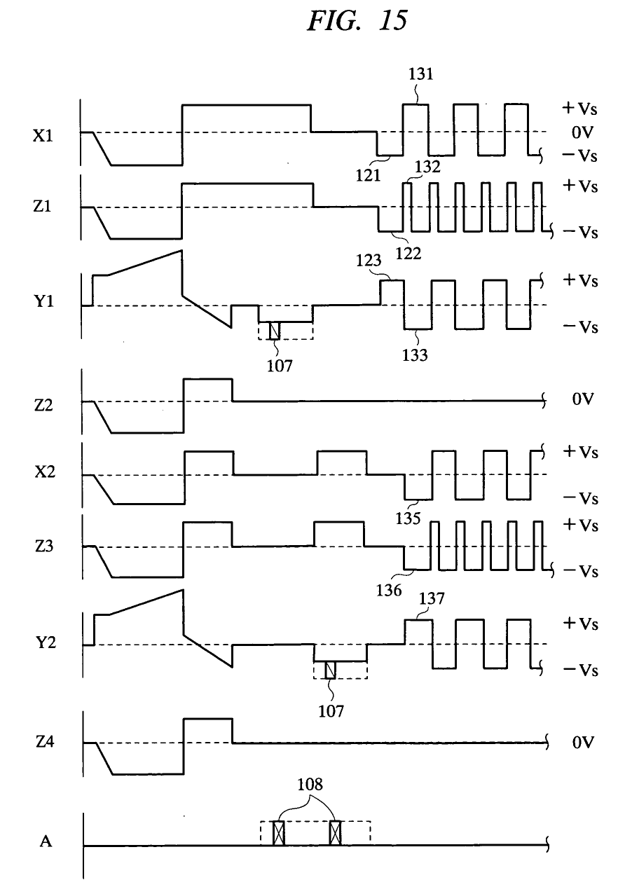

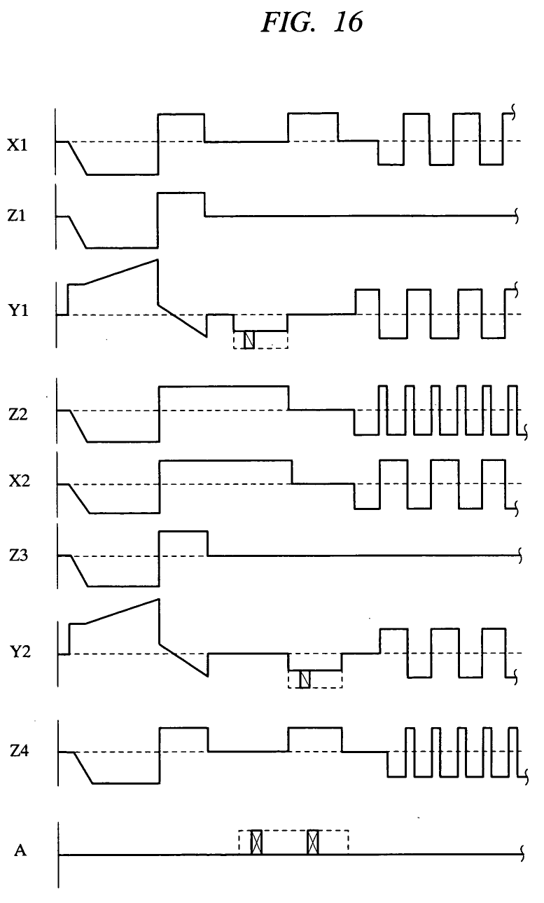

FIG. 15 and FIG. 16 are drawings showing the driving waveforms of the PDP device according to the second embodiment. FIG. 15 shows driving waveforms in the odd-number fields, and FIG. 16 shows driving waveforms in the even-number fields. Driving waveforms to be applied to the X electrodes, the Y electrodes, and the address electrodes are identical to those described in Patent Document 4. A driving waveform identical to that applied to the Z electrode in the first embodiment is applied to the Z electrode provided between the X electrode and the Y electrode where the discharge is performed, and a slightly different driving waveform is applied to the Z electrode provided between the X electrode and the Y electrode where the discharge is not performed.

The driving waveforms in the reset period are the same as the driving waveforms of the first and second embodiments, and all of the cells are brought into a uniform state in the reset period.

In the first half of the address period, a predetermined voltage (for example, +Vs) is applied to the odd-numbered X electrode X1 and the Z electrode of the first group Z1, the even-numbered X electrode X2, the even numbered Y electrode Y2, and the Z electrodes of the second to fourth groups Z2 to Z4 are set to be at 0 V, and a predetermined negative voltage is applied to the odd-numbered Y electrode Y1. In this state, a scan pulse 107 is further applied sequentially. In accordance with the application of the scan pulse 107, the address pulse 108 is applied to the address electrode of the cell to be turned on. Consequently, a discharge is generated between the odd-numbered Y electrode Y1 to which the scan pulse has been applied and the address electrode to which the address pulse has been applied, and this discharge triggers the generation of a discharge between the odd-numbered X electrode X1 and the odd-numbered Y electrode Y1 and between the Z electrode of the first group Z1 and the odd-numbered Y electrode Y1. Through this address discharge, negative wall charge is formed near the odd-numbered X electrode X1 and the Z electrode of the first group Z1 (on the surface of the dielectric layer), and positive wall charge is formed near the odd-numbered Y electrode Y1. In the cell to which the address pulse or the scan pulse is not applied, the wall charge at the time of the reset is maintained since the address discharge is not generated. In the first half of the address period, the scan pulse is applied sequentially to all of the odd-numbered Y electrodes Y1 so as to perform the above-described operations.

In the latter half of the address period, the predetermined voltage is applied to the even-numbered X electrode X2 and the Z electrode of the third group Z3, the odd-numbered X electrode X1, the odd-numbered Y electrode Y1, and the Z electrodes of the first, second and fourth groups Z1, Z2, and Z4 are set to be at 0 V, and the predetermined negative voltage is applied to the even-numbered Y electrode Y1. In this state, a scan pulse 107 is further applied sequentially. In accordance with the application of the scan pulse 107, the address pulse 108 is applied to the address electrode of the cell which is to be turned on. Consequently, a discharge is generated between the even-numbered Y electrode Y2 to which the scan pulse has been applied and the address electrode to which the address pulse has been applied, and this discharge triggers the generation of a discharge between the even-numbered X electrode X2 and the even-numbered Y electrode Y2 and between the Z electrode of the third group Z3 and the even-numbered Y electrode Y2. Through this address discharge, negative wall charge is formed near the even-numbered X electrode X2 and the Z electrode of the third group Z3, and positive wall charge is formed near the even-numbered Y electrode Y2. In the latter half of the address period, the scan pulse is applied sequentially to all of the even-numbered Y electrodes Y2 so as to perform the above-described operations.

The address operations between the odd-numbered X electrodes X1 and the odd-numbered Y electrodes Y1 and between the even-numbered X electrodes X2 and the even-numbered Y electrodes Y2, i.e., the address operations on the odd-number display lines are completed in the above-described manner. In the cells in which the address discharge has been performed, positive wall charge is formed near the odd-numbered and even-numbered Y electrodes Y1 and Y2, and negative wall charge is formed near the odd-numbered and even-numbered X electrodes X1 and X2 and the Z electrodes of the first and third groups Z1 and Z3.

In the sustain discharge period, first, negative sustain discharge pulse 121 of the voltage −Vs is applied to the odd-numbered X electrode X1, positive sustain discharge pulse 123 of the voltage +Vs are applied to the odd-numbered Y electrode Y1, a negative pulse 122 of the voltage −Vs is applied to the Z electrode of the first group Z1. 0 V is applied to the even-numbered X and Y electrodes X2 and Y2. In the sustain discharge period, 0 V is applied to the Z electrode of the second group Z2 and the Z electrode of the fourth group Z4. In the odd-numbered X electrode X1, the voltage by the negative wall charge is superposed on the voltage −Vs, and the voltage by the positive wall charge is superposed on the voltage +Vs in the odd-numbered Y electrode Y1. As a result, a large voltage is applied therebetween. Consequently, as described in the first embodiment, a slight discharge is first started between the Z electrode of the first group Z1 and the odd-numbered Y electrode Y1 where the distance therebetween is narrow, and this discharge triggers a shift to a discharge between the odd-numbered X electrode X1 and the odd-numbered Y electrode Y1 where the distance therebetween is wide. When this discharge is completed, positive wall charge is formed near the odd-numbered X electrode X1 and the Z electrode of the first group Z1, and negative wall charge is formed near the odd-numbered Y electrode Y1.

A voltage Vs is applied to the odd-numbered Y electrode Y1, 0 V is applied to the Z electrode of the second group Z2, and a voltage by the positive wall charges is superposed on the voltage of the odd-numbered Y electrode Y1. Therefore, the voltage between the odd-numbered Y electrode Y1 and the Z electrode of the second group Z2 is increased. However, since the voltage applied to the Z electrode of the second group Z2 is 0 V and no wall charges are formed in the Z electrode of the second group Z2, the voltage by the wall charges is not superposed. Therefore, the voltage does not reach the firing voltage, and no discharge occurs. Similarly, no discharge occurs between the even-numbered X electrode X2 and the Z electrode of the second group Z2. Here, the voltage to be applied to the Z electrode of the second group Z2 is required to have a voltage value which does not generate the discharge. However, the voltage to be applied to the Z electrode of the second group Z2 is preferably lower than the voltage +Vs applied to the adjacent odd-numbered Y electrode Y1 and even-numbered X electrode X2. This is for the following reason. When a sustain discharge is generated between the odd-numbered X electrode X1 and the odd-numbered Y electrode Y1, mobile electrons move from the odd-numbered X electrode X1 to the odd-numbered Y electrode Y1. However, if the voltage of the Z electrode of the second group Z2 is the same as the voltage of the odd-numbered Y electrode Y1, the electrons directly move to the Z electrode of the second group Z2, and then reach the even-numbered X electrode X2. In such a case, when the sustain discharge pulse of the opposite polarity is then applied, an erroneous discharge is generated and a display error occurs. On the other hand, when the voltage of the Z electrode of the second group Z2 is set to 0 V like the present embodiment, since it is lower than the voltage of the odd-numbered Y electrode Y1, the movement of the electrons can be prevented and the occurrence of erroneous discharges between adjacent display lines can be prevented.

The above-described conditions can be applied to the Z electrode of the fourth group Z4 provided between the even-numbered Y electrode Y2 and the odd-numbered X electrode X1.

Next, positive sustain discharge pulses 131 and 137 of a voltage +Vs are applied to the odd-numbered X electrode X1 and the even-numbered Y electrode Y2, respectively, negative sustain discharge pulses 133 and 135 of a voltage −Vs are applied to the odd-numbered Y electrode Y1 and the even-numbered X electrode X2, respectively, a positive short pulse 132 of a voltage +Vs is applied to the Z electrode of the first group Z1, and a negative pulse 136 of a voltage −Vs is applied to the Z electrode of the third group Z3. In the odd-numbered X electrode X1 and the Z electrode of the first group Z1, as described above, positive wall charges are formed by the previous sustain discharge, and the resulting voltage is superposed on the voltage +Vs. In the odd-numbered Y electrode Y1, a voltage by the negative wall charges is superposed on the voltage −Vs by the previous sustain discharge. Consequently, a large voltage is applied between the electrodes. Furthermore, in the even-numbered X electrode X2 and the Z electrode of the third group Z3, negative wall charges at the time of address end are maintained, and the resulting voltage is superposed on the voltage −Vs. In the even-numbered Y electrode Y2, positive wall charges at the time of address end are maintained, and the resulting voltage is superposed on the voltage +Vs. Consequently, a large voltage is applied between the electrodes. Accordingly, slight discharges are started between the Z electrode of the first group Z1 and the odd-numbered Y electrode Y1 and between the Z electrode of the third group Z3 and the even-numbered Y electrode Y2 where the distances therebetween are narrow, and these discharges trigger the shifts to discharges between the odd-numbered X electrode X1 and the odd-numbered Y electrode Y1 and between the even-numbered X electrode X2 and the even-numbered Y electrode Y2 where the distances therebetween are wide.

Similar to the first embodiment, after the positive short pulse 132 is applied to the Z electrode of the first group Z1, the voltage to be applied to the Z electrode of the first group Z1 is changed to −Vs. Therefore, after the main discharge between the odd-numbered X electrode X1 and the even-numbered Y electrode Y1 is completed, negative wall charges are formed near the odd-numbered X electrode X1, and positive wall charges are formed near the Z electrode of the first group Z1 and the odd-numbered Y electrode Y1. Also, positive wall charges are formed near the even-numbered X electrode X2 and the Z electrode of the third group Z3, and negative wall charges are formed near the even-numbered Y electrode Y2.

Next, a negative sustain discharge pulse of a voltage −Vs is applied to the odd-numbered X electrode X1 and the even-numbered Y electrode Y2, a positive sustain discharge pulse of a voltage +Vs is applied to the odd-numbered Y electrode Y1 and the even-numbered X electrode X2, and a positive short pulse of a voltage −Vs is applied to the Z electrode of the first group Z1 and the Z electrode of the third group Z3. By doing so, a discharge between the odd-numbered X electrode X1 and the Z electrode of the first group Z1 triggers a sustain discharge between the odd-numbered X electrode X1 and the odd-numbered Y electrode Y1. Similarly, a discharge between the even-numbered Y electrode Y2 and the Z electrode of the third group Z3 triggers a sustain discharge between the even-numbered X electrode X2 and the even-numbered Y electrode Y2. Thereafter, by applying a sustain discharge pulse while reversing its polarity, the sustain discharge is repeated.

As described above, the first sustain discharge is generated only between the odd-numbered X electrode X1 and the odd-numbered Y electrode Y1, and it is not generated between the even-numbered X electrode X2 and the even-numbered Y electrode Y2. Therefore, it is controlled so that a sustain discharge is generated only between the even-numbered X electrode X2 and the even-numbered Y electrode Y2 and no discharge is generated between the odd-numbered X electrode X1 and the odd-numbered Y electrode Y1 at the end of the sustain discharge period. By doing so, the numbers of times of the sustain discharges are made equal to each other.

In the foregoing, the driving waveforms of the odd-number field have been described. In the driving waveforms of the even-number field, the same driving waveforms as those in the odd-number field are applied to the odd-numbered and even-numbered Y electrodes Y1 and Y2, the driving waveform applied to the even-numbered X electrode X2 of the odd-number field is applied to the odd-numbered X electrode X1, the driving waveform applied to the odd-numbered X electrode X1 of the odd-number field is applied to the even-numbered X electrode X2, the waveform applied to the Z electrode of the second group Z2 of the odd-number field is applied to the Z electrode of the first group Z1, the driving waveform applied to the Z electrode of the first group Z1 of the odd-number field is applied to the Z electrode of the second group Z2, the driving waveform applied to the Z electrode of the fourth group Z4 of the odd-number field is applied to the Z electrode of the third group Z3, and the driving waveform applied to the Z electrode of the third group Z3 of the odd-number field is applied to the Z electrode of the fourth group Z4.

In the foregoing, the PDP device of the second embodiment has been described. Note that the modification example described in the first embodiment can be applied to the ALIS PDP device of the second embodiment. For example, it is possible to apply a driving waveform in which a thin pulse is applied to the Z electrode in the sustain discharge period in the structure where the edges of the X discharge electrode and the Y discharge electrode opposing to the Z electrode form a predetermined angle with respect to the extending direction of the Z electrode.

(Note 1)

A plasma display panel comprises:

a plurality of first, second, and third electrodes disposed to be adjacent to each other and extending in a first direction, the third electrodes being provided respectively between the first and second electrodes where discharges are to be repeated; and

a dielectric layer covering the plurality of first, second, and third electrodes,

wherein a space between the first electrode and the second electrode for performing sustain discharges is approximately constant over an entire display area width of the plasma display panel, and

a space between the third electrode and the first and second electrodes is varied depending on positions in the entire display area width of the plasma display panel in the first direction. (1)

(Note 2)

In the plasma display panel according to note 1, the first electrode is formed of a first transparent electrode which allows visible light to pass and a first metal electrode having a electrical resistance value lower than that of the first transparent electrode, and the second electrode is formed of a second transparent electrode which allows visible light to pass and a second metal electrode having an electrical resistance value lower than that of the second transparent electrode, and

the first metal electrode and the second metal electrode are parallel to each other over the entire display area width of the plasma display panel. (2)

(Note 3)

In the plasma display panel according to note 2, the first transparent electrode and the second transparent electrode have portions protruding from the first transparent electrode and the second metal electrode for each cell, and opposing edges of the protruding portions of the first transparent electrode and the second transparent electrode are approximately parallel to the first metal electrode and the second metal electrode. (3)

(Note 4)

In the plasma display panel according to note 2 or 3, the third electrode is formed of a third transparent electrode which allows visible light to pass and a third metal electrode having an electrical resistance value lower than that of the third transparent electrode, and

the third metal electrode and the third transparent electrode linearly extend over the entire display area width of the plasma display panel to form a predetermined angle with the first metal electrode and the second metal electrode. (4)

(Note 5)

In the plasma display panel according to note 2 or 3, the third electrode is formed of a third transparent electrode which allows visible light to pass and a third metal electrode having an electrical resistance value lower than that of the third transparent electrode, and

edges of the third metal electrode and the third transparent electrode have a stepwise shape and are parallel to edges of the first metal electrode and the second metal electrode, in which a space from the edges of the first metal electrode and the second metal electrode is varied stepwise in the first direction over the entire display area width of the plasma display panel. (5)

(Note 6)

In the plasma display panel according to note 2 or 3,

wherein the third electrode is formed of a third transparent electrode which allows visible light to pass and a third metal electrode having an electrical resistance value lower than that of the third transparent electrode, and

the third metal electrode and the third transparent electrode extend in a zigzag manner over the entire display area width of the plasma display panel. (6)

(Note 7)

In the plasma display panel according to note 2 or 3, the third electrode is formed of a third transparent electrode which allows visible light to pass and a third metal electrode having an electrical resistance value lower than that of the third transparent electrode,

the third metal electrode linearly extends over the entire display area width of the plasma display panel approximately in parallel to the first metal electrode and the second metal electrode, and

an edge of the third transparent electrode linearly extends over the entire display area width of the plasma display panel to form a predetermined angle with the first metal electrode and the second metal electrode, and a space between the edge of the third transparent electrode and the edges of the first and second transparent electrodes is varied depending on positions in the entire display area width of the plasma display panel in the first direction. (7)

(Note 8)

In the plasma display panel according to note 7, a width of the third transparent electrode is approximately constant over the entire display area width of the plasma display panel in the first direction.

(Note 9)

In the plasma display panel according to note 7, a width of the third transparent electrode is varied over the entire display area width of the plasma display panel in the first direction.

(Note 10)

In the plasma display panel according to note 9, the width of the third transparent electrode is large at center in the display area width of the plasma display panel and is small at portions near ends of the display area width in the first direction, and

a space between the edge of the third transparent electrode and the edges of the first transparent electrode and the second transparent electrode is narrow at center of the display area width of the plasma display panel and is wide at portions near the ends of the display area width in the first direction.

(Note 11)

In the plasma display panel according to note 9, the width of the third transparent electrode is small at center in the display area width of the plasma display panel and is large at portions near ends of the display area width in the first direction, and

a space between the edge of the third transparent electrode and the edges of the first transparent electrode and the second transparent electrode is wide at center of the display area width of the plasma display panel and is narrow at portions near the ends of the display area width in the first direction.

(Note 12)

In the plasma display panel according to note 2 or 3, the third electrode is formed of a third transparent electrode which allows visible light to pass, and

an edge of the third transparent electrode linearly extends over the entire display area width of the plasma display panel to form a predetermined angle with the first metal electrode and the second metal electrode. (8)

(Note 13)

In the plasma display panel according to note 12, a width of the third transparent electrode is approximately constant over the entire display area width of the plasma display panel in the first direction.

(Note 14)

In the plasma display panel according to note 12, a width of the third transparent electrode is varied over the entire display area width of the plasma display panel in the first direction.

(Note 15)

In the plasma display panel according to note 14, the width of the third transparent electrode is large at center in the display area width of the plasma display panel and is small at portions near ends of the display area width in the first direction, and

a space between the edge of the third transparent electrode and the edges of the first transparent electrode and the second transparent electrode is narrow at center of the display area width of the plasma display panel and is wide at portions near the ends of the display area width in the first direction.

(Note 16)

In the plasma display panel according to note 14, the width of the third transparent electrode is small at center in the display area width of the plasma display panel and is large at portions near ends of the display area width in the first direction, and

a space between the edge of the third transparent electrode and the edges of the first transparent electrode and the second transparent electrode is wide at center of the display area width of the plasma display panel and is narrow at portions near the ends of the display area width in the first direction.

(Note 17)

In the plasma display panel according to note 2 or 3, the third electrode is formed of a third transparent electrode which allows visible light to pass and a third metal electrode having an electrical resistance value lower than an electrical resistance value of the third parent electrode,

the third metal electrode linearly extends over the entire display area width of the plasma display panel approximately in parallel to the first metal electrode and the second metal electrode, and

an edge of the third transparent electrode extends in a zigzag manner over the entire display area width of the plasma display panel, and a space between the edge of the third transparent electrode and edges of the first transparent electrode and the second transparent electrodes is periodically varied over the entire display area width of the plasma display panel in the first direction.

(Note 18)

In the plasma display panel according to note 16, a width of the third transparent electrode is approximately constant over the entire display area width of the plasma display panel in the first direction.

(Note 19)

In the plasma display panel according to note 16, a width of the third transparent electrode is periodically varied over the entire display area width of the plasma display panel in the first direction.

(Note 20)

In the plasma display panel according to any one of notes 1 to 19, the dielectric layer is made of silicide formed through vapor-phase deposition and has a thickness of 10 μm or smaller.

(Note 21)

In a plasma display device comprising the plasma display panel according to any one of notes 1 to 20, when a sustain discharge is performed between the first electrode and the second electrode, simultaneously with or earlier than a time when a sustain discharge voltage is applied between the first electrode and the second electrode, a predetermined voltage is applied between the third electrode and the first electrode or the second electrode, thereby generating a discharge between the first electrode or the second electrode and the third electrode, and the discharge triggers a sustain discharge between the first electrode and the second electrode. (9)

(Note 22)

In the plasma display device according to note 21, immediately after the sustain discharge occurs between the first electrode and the second electrode, a voltage to be applied to the third electrode is switched so that a predetermined voltage is applied between the third electrode and the other of the first electrode and the second electrode, thereby stopping the discharge between one of the first electrode and the second electrode and the third electrode. (10)

As described above, according to the present invention, the sustain discharge current can be distributed without generating luminance nonuniformity. Therefore, it is possible to reduce a peak value of the sustain discharge current. Accordingly, X and Y electrode driving circuits can be configured of elements with a relatively low driving capability. Thus, it is possible to provide a plasma display panel which can realize a PDP device having good display quality at low cost.

What is claimed is:

1. A plasma display panel comprising:
a plurality of first, second, and third electrodes disposed to be adjacent to each other and extending in a first direction, said third electrodes being provided respectively between said first and second electrodes where discharges are to be repeated; and
a dielectric layer covering said plurality of first, second, and third electrodes,
wherein a space between said first electrode and said second electrode for performing the discharges is approximately constant over an entire display area width of the plasma display panel, and
a space between said third electrode and said first and second electrodes is varied depending on positions in the entire display area width of the plasma display panel in said first direction.

2. The plasma display panel according to claim 1,
wherein said first electrode is formed of a first transparent electrode which allows visible light to pass and a first metal electrode having a electrical resistance value lower than that of the first transparent electrode, and said second electrode is formed of a second transparent electrode which allows visible light to pass and a second metal electrode having an electrical resistance value lower than that of the second transparent electrode, and
said first metal electrode and said second metal electrode are parallel to each other over the entire display area width of the plasma display panel.

3. The plasma display panel according to claim 2,
wherein said first transparent electrode and said second transparent electrode have portions protruding from said first transparent electrode and said second metal electrode for each cell, and opposing edges of the protruding portions of said first transparent electrode and said second transparent electrode are approximately parallel to said first metal electrode and said second metal electrode.

4. The plasma display panel according to claim 3,
wherein said third electrode is formed of a third transparent electrode which allows visible light to pass and a third metal electrode having an electrical resistance value lower than that of the third transparent electrode, and
said third metal electrode and said third transparent electrode linearly extend over the entire display area width of the plasma display panel to form a predetermined angle with said first metal electrode and said second metal electrode.

5. The plasma display panel according to claim 3,
wherein said third electrode is formed of a third transparent electrode which allows visible light to pass and a third metal electrode having an electrical resistance value lower than that of the third transparent electrode, and
edges of said third metal electrode and said third transparent electrode have a stepwise shape and are parallel to edges of said first metal electrode and said second metal electrode, in which a space from the edges of said first metal electrode and said second metal electrode is varied stepwise in said first direction over the entire display area width of the plasma display panel.

6. The plasma display panel according to claim 3,
wherein said third electrode is formed of a third transparent electrode which allows visible light to pass and a third metal electrode having an electrical resistance value lower than that of the third transparent electrode, and
said third metal electrode and said third transparent electrode extend in a zigzag manner over the entire display area width of the plasma display panel.

7. The plasma display panel according to claim 3,
wherein said third electrode is formed of a third transparent electrode which allows visible light to pass and a third metal electrode having an electrical resistance value lower than that of the third transparent electrode,
said third metal electrode linearly extends over the entire display area width of the plasma display panel approximately in parallel to said first metal electrode and said second metal electrode, and
an edge of said third transparent electrode linearly extends over the entire display area width of the plasma display panel to form a predetermined angle with said first metal electrode and said second metal electrode, and a space between the edge of said third transparent electrode and the edges of said first and second transparent electrodes is varied depending on positions in the entire display area width of the plasma display panel in said first direction.

8. The plasma display panel according to claim 3,
wherein said third electrode is formed of a third transparent electrode which allows visible light to pass, and
an edge of said third transparent electrode linearly extends over the entire display area width of the plasma display panel to form a predetermined angle with said first metal electrode and said second metal electrode.

9. A plasma display device comprising a plasma display panel which comprises: a plurality of first, second, and third electrodes disposed to be adjacent to each other and extending in a first direction, said third electrodes being provided respectively between said first and second electrodes where discharges are to be repeated; and a dielectric layer covering said plurality of first, second, and third electrodes, in which a space between said first electrode and said second electrode for performing the discharges is approximately constant over an entire display area width of the plasma display panel, and a space between said third electrode and said first and second electrodes is varied depending on positions in the entire display area width of the plasma display panel in said first direction,
wherein, when a sustain discharge is performed between said first electrode and said second electrode, simultaneously with or earlier than a time when a sustain discharge voltage is applied between said first electrode and said second electrode, a predetermined voltage is applied between said third electrode and said first electrode or said second electrode, thereby generating a discharge between said first electrode or said second electrode and said third electrode, and the discharge triggers a sustain discharge between said first electrode and said second electrode.

10. The plasma display device according to claim 9,
wherein said first electrode is formed of a first transparent electrode which allows visible light to pass and a first metal electrode having a electrical resistance value lower than that of the first transparent electrode, and said second electrode is formed of a second transparent electrode which allows visible light to pass and a second metal electrode having an electrical resistance value lower than that of the second transparent electrode, and
said first metal electrode and said second metal electrode are parallel to each other over the entire display area width of the plasma display panel.

11. The plasma display device according to claim 10,
wherein said first transparent electrode and said second transparent electrode have portions protruding from said first transparent electrode and said second metal electrode for each cell, and opposing edges of the protruding portions of said first transparent electrode and said second transparent electrode are approximately parallel to said first metal electrode and said second metal electrode.

12. The plasma display device according to claim 11,
wherein said third electrode is formed of a third transparent electrode which allows visible light to pass and a third metal electrode having an electrical resistance value lower than that of the third transparent electrode, and
said third metal electrode and said third transparent electrode linearly extend over the entire display area width of the plasma display panel to form a predetermined angle with said first metal electrode and said second metal electrode.
